(19) United States
(12) Patent Application Publication
(10) Pub. No.: US 2026/0005261 A1
(43) Pub. Date: Jan. 1, 2026

(54) BIODEGRADABLE BATTERY SYSTEM WITH MODULAR ENERGY PODS

(71) Applicant: Magvolts Energy, Inc., San Diego, CA (US)

(72) Inventor: Irene Hsu Chen, San Diego, CA (US)

(21) Appl. No.: 19/232,708

(22) Filed: Jun. 9, 2025

Related U.S. Application Data
(60) Provisional application No. 63/666,605, filed on Jul. 1, 2024.

(51) Int. Cl. H01M 6/04; G06K 7/10; G06K 7/14; G06Q 20/18; G07F 11/46; H01M 4/38; H01M 6/32; H01M 6/42; H01M 6/50

(52) U.S. Cl. CPC H01M 6/045; G06K 7/10366; G06K 7/1417; G06Q 20/18; G07F 11/46; H01M 4/38; H01M 6/32; H01M 6/42; H01M 6/505; H01M 6/5088; H01M 2300/0005

(57) ABSTRACT

The present disclosure provides a modular biodegradable battery system addressing limitations of conventional batteries. The system comprises removable energy pods, each containing a first electrode, a second electrode, separate compartments for organic material and vinegar, and an activation mechanism to mix these components into a biodegradable slurry. A reusable modular base removably couples with the energy pods. This design enables customizable power configurations while utilizing environmentally friendly materials. The activation mechanism allows on-demand power generation, overcoming shelf-life issues of pre-mixed biodegradable batteries. The modular base facilitates easy replacement of depleted pods and supports series or parallel connections for voltage or current amplification. This system offers a sustainable alternative to traditional batteries, reducing electronic waste and environmental impact.

### CROSS-REFERENCE TO RELATED APPLICATIONS

This application claims the benefit of and priority to U.S. Provisional Application No. 63/666,605, titled “BIODEGRADABLE CELL BATTERY CONFIGURATIONS AND SYSTEMS WITH CUSTOMIZABLE GREEN ENERGY SOLUTIONS”, filed Jul. 1, 2024, which is hereby incorporated by reference in its entirety.

### FIELD OF THE INVENTION

The present disclosure relates to energy storage technologies, and more particularly to biodegradable cell battery configurations and systems that provide customizable green energy solutions.

### BACKGROUND

The field of energy storage technologies faces significant challenges in developing environmentally friendly and sustainable power solutions. As the demand for portable and renewable energy sources continues to grow, there is an increasing need for battery systems that can provide reliable power while minimizing environmental impact. This issue has become particularly important due to concerns about electronic waste and the long-term effects of non-biodegradable battery components on ecosystems.

Existing battery systems attempting to address these environmental concerns encounter several obstacles. These include limitations in energy density, difficulties in recycling or safely disposing of battery materials, and challenges in creating modular designs that allow for easy replacement or upgrades of individual components. Additionally, many current battery technologies rely on rare or potentially harmful materials, which can lead to supply chain issues and environmental risks during extraction and processing.

For instance, in portable electronic devices, current battery solutions often fail to provide an adequate balance between performance and environmental sustainability. Users may find themselves frequently replacing entire battery units, contributing to electronic waste. Another example is in the context of renewable energy storage, where existing methods are unable to offer scalable and biodegradable options for storing excess power generated from sources like solar or wind. These shortcomings highlight the need for innovative approaches to battery design that can address both performance requirements and environmental considerations.

As such, there is thus a need for addressing these and/or other issues associated with the prior art.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a modular biodegradable battery system, including: a plurality of removable energy pods, each energy pod including: a first electrode and a second electrode; a compartment containing organic material; a separate compartment containing vinegar; an activation mechanism configured to initiate mixing of the organic material and the vinegar to create a biodegradable slurry mixture upon activation; and a reusable modular base configured to removably couple with one or more of the energy pods.

In some aspects, the techniques described herein relate to a modular biodegradable battery system, wherein: the organic material includes at least one of lemon zest, banana, berries, orange zest, apples, grapes, or pineapple; and the biodegradable slurry mixture includes a 1:1 ratio of organic material and vinegar.

In some aspects, the techniques described herein relate to a modular biodegradable battery system, wherein: the first electrode includes magnesium; and the second electrode includes copper.

In some aspects, the techniques described herein relate to a modular biodegradable battery system, wherein the activation mechanism includes: a breakable scal between the compartment containing organic material and the separate compartment containing vinegar; and a mechanical agitator configured to mix the organic material and vinegar upon activation.

In some aspects, the techniques described herein relate to a modular biodegradable battery system, wherein the reusable modular base includes: a circular form factor; base circuitry arranged in a grid pattern on an upper surface of the modular base; and an activation switch positioned on a side of the modular base.

In some aspects, the techniques described herein relate to a modular biodegradable battery system, wherein the reusable modular base further includes: a feedback indicator positioned opposite the activation switch; and the feedback indicator is configured to provide visual information about a status of the battery system.

In some aspects, the techniques described herein relate to a modular biodegradable battery system, wherein: the reusable modular base includes a magnetic coupling mechanism; and each energy pod includes a corresponding magnetic coupling mechanism configured to removably secure the energy pod to the reusable modular base.

In some aspects, the techniques described herein relate to a modular biodegradable battery system, wherein: the magnetic coupling mechanism of the reusable modular base includes an array of magnets arranged to create a strong and uniform connection across an interface with the energy pod; and the magnetic coupling mechanism is configured to align the energy pod correctly with the reusable modular base.

In some aspects, the techniques described herein relate to a modular biodegradable battery system, wherein each energy pod further includes: a biodegradable casing enclosing the first electrode, the second electrode, and the compartments; and the biodegradable casing is configured to degrade naturally over time after the energy pod is depleted.

In some aspects, the techniques described herein relate to a modular biodegradable battery system, wherein: the biodegradable casing includes multiple layers, each layer serving a specific function; and the functions include at least two of: electrolyte containment, moisture barrier, structural support, or controlled degradation.

In some aspects, the techniques described herein relate to a modular biodegradable battery system, wherein: the reusable modular base is configured to connect multiple energy pods in series; and the series connection amplifies a voltage output of the battery system.

In some aspects, the techniques described herein relate to a modular biodegradable battery system, wherein: the reusable modular base is configured to connect multiple energy pods in parallel; and the parallel connection amplifies a current output of the battery system.

In some aspects, the techniques described herein relate to a modular biodegradable battery system, further including: a vending machine configured to store and dispense the plurality of removable energy pods; and the vending machine includes a transparent front panel displaying multiple rows of energy pods arranged in a grid pattern.

In some aspects, the techniques described herein relate to a modular biodegradable battery system, wherein the vending machine further includes: a control panel with a user interface for selecting and purchasing energy pods; a payment processing component supporting multiple payment methods; and a dispensing slot with a secure mechanism to prevent unauthorized access to the energy pods.

In some aspects, the techniques described herein relate to a modular biodegradable battery system, wherein: each energy pod includes an RFID tag or QR code; and the vending machine includes a scanner configured to read the RFID tag or QR code for automated inventory tracking and providing information about pod specifications and compatibility.

In some aspects, the techniques described herein relate to a modular biodegradable battery system, further including: a composting container configured to collect and process depleted energy pods; and the composting container is designed to maintain optimal conditions for decomposition of the biodegradable components of the energy pods.

In some aspects, the techniques described herein relate to a modular biodegradable battery system, wherein the composting container includes: multiple compartments to accommodate different stages of the decomposition process; sensors to monitor temperature, humidity, and pH levels; and an automated mixing mechanism to ensure consistent decomposition of the energy pods.

In some aspects, the techniques described herein relate to a modular biodegradable battery system, wherein: the first electrode and the second electrode are treated with surface modifications to enhance performance and longevity; and the electrodes incorporate porous structures or nanoparticle coatings to increase effective surface area for improved electrical performance.

In some aspects, the techniques described herein relate to a modular biodegradable battery system, wherein: the reusable modular base includes a wireless communication module; and the wireless communication module is configured to transmit data regarding battery performance, charge status, and usage patterns to a remote monitoring system.

In some aspects, the techniques described herein relate to a modular biodegradable battery system, wherein: the reusable modular base further includes a microcontroller; and the microcontroller is configured to optimize power distribution based on real-time analysis of the transmitted data and connected energy pod configurations.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 illustrates a flowchart for creating a green energy solution using biodegradable resources, according to aspects of the present disclosure.

FIG. 2A depicts a schematic layout of a battery configuration with multiple basic battery units connected in series, according to aspects of the present disclosure.

FIG. 2B depicts a schematic layout of a battery configuration with multiple basic battery units connected in parallel, according to aspects of the present disclosure.

FIG. 3 shows two views of a component of the innovative battery design, highlighting the cell pouch, slurry mixture, and electrodes, according to aspects of the present disclosure.

FIG. 4 presents a battery configuration with multiple basic battery units and their interconnections, according to aspects of the present disclosure.

FIG. 5 outlines a flowchart of a battery creation process, emphasizing the provision of a battery configuration and the configuration of a biodegradable electrolyte, according to aspects of the present disclosure.

FIG. 6 demonstrates various configurations of a battery design, showcasing the versatility and modularity of the design, according to aspects of the present disclosure.

FIG. 7 provides an isometric view of a battery unit, according to aspects of the present disclosure.

FIG. 8 displays an internal view of an electronic device, highlighting the integration of the biodegradable cell battery within the device, according to aspects of the present disclosure.

FIG. 9 illustrates a top view of a battery configuration with a modular base, according to aspects of the present disclosure.

FIG. 10 illustrates an orthogonal view of a battery assembly with multiple sections, according to an embodiment.

FIG. 11 illustrates a side view of a battery assembly with an energy pod and modular base, according to aspects of the present disclosure.

FIG. 12 illustrates a front view of a vending machine for dispensing energy pods, according to an embodiment.

FIG. 13 illustrates a composting process for a used energy pod, according to aspects of the present disclosure.

FIG. 14 illustrates a battery configuration showing an arrangement of multiple energy pods in a grid pattern, in accordance with one embodiment.

FIG. 15 illustrates an exploded view of a battery assembly comprising a disposable pod tray and a reusable tray lid, in accordance with one embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to the field of energy storage technologies, specifically focusing on biodegradable battery systems with modular energy pods that provide customizable green energy solutions. This area of technology addresses the growing demand for portable and renewable energy sources while minimizing environmental impact.

Current energy storage solutions face significant challenges in developing environmentally friendly and sustainable power options. Existing battery systems often struggle with limitations in energy density, difficulties in recycling or safely disposing of battery materials, and challenges in creating modular designs that allow for easy replacement or upgrades of individual components. Additionally, many current battery technologies rely on rare or potentially harmful materials, which can lead to supply chain issues and environmental risks during extraction and processing.

The present disclosure introduces a novel battery configuration that utilizes biodegradable materials and a unique electrolyte composition, significantly increasing environmental sustainability while maintaining performance. The battery system comprises multiple battery units with electrodes made from readily available materials such as magnesium and copper, combined with an electrolyte composed of organic material and vinegar. This approach addresses the environmental concerns associated with traditional battery systems while providing reliable power output.

Furthermore, the present disclosure incorporates an innovative modular design that allows for easy scaling and customization of the battery system. The battery units can be arranged in series or parallel configurations to amplify voltage or current output as needed. The system also features an activation mechanism for initiating the mixing of organic material and vinegar to create a biodegradable slurry, enhancing the overall efficiency and longevity of the battery. Additionally, the modular nature of the energy pods enables easy replacement and environmentally friendly disposal through composting, further reducing the ecological footprint of the energy storage solution.

Overall, the innovative battery design described herein offers a sustainable, scalable, and customizable energy storage solution that harnesses the power of biodegradable materials and modular configuration.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Exemplary Embodiments

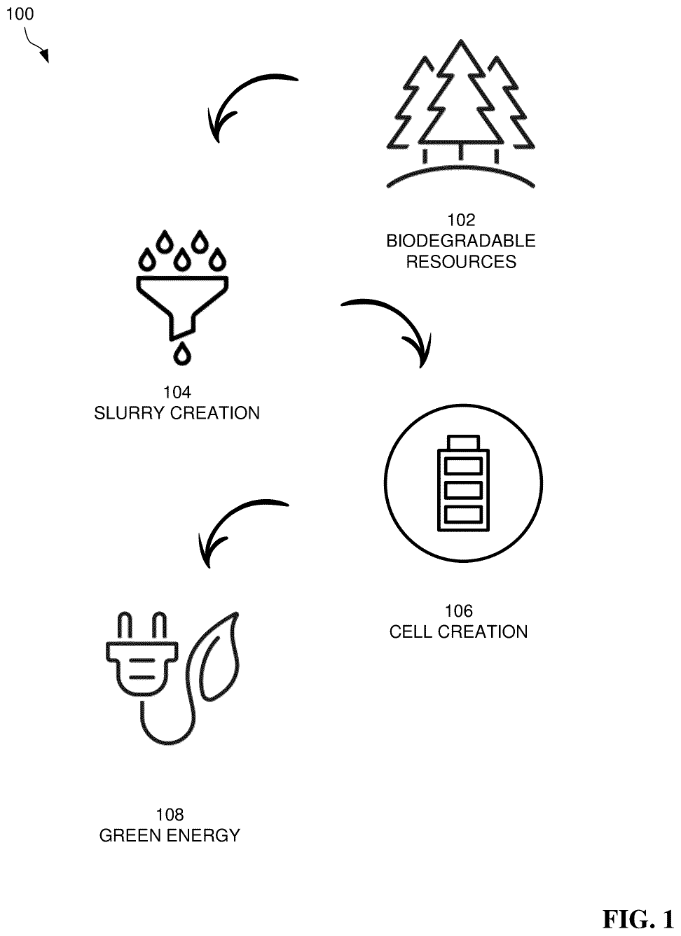

FIG. 1 illustrates a flowchart process 100 for creating a green energy solution using biodegradable resources, in accordance with one embodiment.

As shown, the flowchart process 100 shows a method for creating a green energy solution using biodegradable resources 102. The process begins with the use of biodegradable resources 102, which may include a variety of organic materials such as fruit peels, vegetable scraps, or other types of food waste. These biodegradable resources 102 may be sourced from local agricultural waste, household compost, or industrial food processing byproducts. The selection of biodegradable resources may be optimized based on factors such as availability, cost-effectiveness, and energy potential.

In various embodiments, the energy output and biodegradability of the organic materials may be optimized by selecting fruit acids, particularly citric acid, for use with magnesium electrodes. The system may utilize any weak acid with a pH range of 2-5 to facilitate an efficient chemical reaction. This combination may provide an optimal balance between energy generation and environmental sustainability.

These biodegradable resources 102 are then processed into a slurry during the slurry creation 104 stage. The slurry may be composed of a mixture of the biodegradable resources 102 and vinegar (and/or another acidic source), forming a biodegradable and non-toxic electrolyte for the battery units. The slurry creation process may involve mechanical grinding, blending, or other methods to achieve a consistent mixture.

It is to be appreciated that the vinegar (and/or another acidic source) may include rice wine vinegar, distilled white vinegar, etc. or other vinegars or liquids below a predetermined pH threshold (such as a pH of 3). The selection of the acidic source may be based on factors such as conductivity, reactivity with the chosen biodegradable resources, and overall performance in the battery system. In some cases, the acidic source may be further processed or refined to enhance its electrical properties or to remove impurities that could affect battery performance.

Following the slurry creation 104, the next step in the process is cell creation 106. During this stage, individual battery units are formed. In one embodiment, the individual battery units may each include a magnesium electrode and a copper electrode. The choice of magnesium and copper (and/or any material) for the electrodes may be based on their electrochemical properties, availability, and compatibility with the biodegradable slurry. It is recognized that other materials may be selected and used for the electrodes.

The slurry created may be used as the electrolyte in the individual battery units. In some cases, the battery units may be individually wrapped with an insulating material, such as plastic or rubber, to prevent leakage of the electrolyte and to enhance the safety and efficiency of the battery configuration. The insulating material may be selected for its durability, chemical resistance, and ability to biodegrade along with the other battery components.

It is to be appreciated that the individual battery units may be configured in any form as desired (e.g. pouch, cylindrical, etc.). The form factor may be chosen based on the intended application, space constraints, or manufacturing considerations. Additionally, in various embodiments, a collection of battery units (in a single form factor and/or modular pod assembly) may be bundled into a resulting battery configuration (e.g. pouch, cylindrical, etc.). This bundling process may involve additional manufacturing steps such as interconnecting the units, adding external casing, or incorporating control circuitry. In various embodiments, the slurry (combination of the acetic source, such as vinegar, and the biomaterial source, such as fruit juice or organic material) may, in combination, have a pH within the range of 2 to 5. This pH range may be carefully controlled to optimize the electrochemical reactions within the battery while maintaining the biodegradability of the components.

The final step in the flowchart process 100 is the generation of green energy 108. This involves the operation of the basic battery units to produce electricity. The electricity generation process may involve complex electrochemical reactions between the electrodes and the biodegradable slurry. The basic battery units may be interconnected in a series circuit, in one embodiment, which may amplify the voltage output of the overall battery configuration. The interconnection may be achieved through various wiring methods or conductive materials compatible with the biodegradable nature of the battery. The basic battery units may be designed to provide a steady voltage output over a period of a few days, offering a reliable and sustainable energy solution. The longevity of the battery may be influenced by factors such as the composition of the biodegradable resources, the efficiency of the electrochemical reactions, and the overall design of the battery units.

In some aspects, the basic battery units may be designed to be biodegradable, aligning with the environmental friendliness of the battery design. The biodegradability may extend to all components of the battery, including electrodes, casing, and insulation materials. The use of biodegradable resources 102 and at least one biodegradable electrolyte in the basic battery units may allow the units to decompose naturally at the end of their lifecycle, reducing the environmental impact of the battery configuration. The decomposition process may be designed to occur within a specific timeframe and under certain environmental conditions to ensure proper disposal.

In some cases, the battery units may be designed to be non-toxic. The non-toxic nature may apply to both the materials used in construction and any byproducts produced during operation or decomposition. The use of non-toxic materials, such as organic materials and vinegar, in the creation of the basic battery units may ensure the safety of the battery configuration, making it suitable for use in a variety of applications, including electric vehicles, consumer electronics, and home power wall generators. The non-toxic design may also facilitate easier handling, transportation, and disposal of the battery units.

In other aspects, the battery units may be designed to be environmentally friendly. This may include considerations beyond biodegradability, such as the energy and resources required for production, the potential for reuse or recycling of components, and the overall carbon footprint of the battery lifecycle. The use of biodegradable resources 102 and at least one biodegradable electrolyte in the basic battery units, along with the potential for the units to be recyclable or compostable, may contribute to the environmental sustainability of the battery configuration. The environmental friendliness may also extend to the manufacturing processes, packaging, and distribution methods used for the battery units.

In various embodiments, the energy pods may be constructed using biodegradable materials such as wax paper or biodegradable plastics derived from lactic acid. This design may allow for direct disposal of used pods into compost bins without the need for special processing or handling. The fully biodegradable nature of the pods may simplify the recycling process and reduce environmental impact.

The process 100 for creating a green energy solution using biodegradable resources forms the foundation for the modular energy pod system described in subsequent figures. Each step of this process—from the selection of biodegradable resources 102, through slurry creation 104 and cell creation 106, to the final generation of green energy 108—may be the basis for the production of individual energy pods. These pods, once created through this process, can then be integrated into the modular battery configurations detailed later. The modularity of the system allows for easy scaling and customization, as multiple energy pods created through this process can be combined in various arrangements to meet specific power requirements. Furthermore, the biodegradable nature of the resources used ensures that each pod, from its creation to its eventual disposal, aligns with the overarching goal of providing sustainable, environmentally friendly energy solutions. This process 100 thus serves as the foundation in realizing the full potential of the modular, biodegradable battery system.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

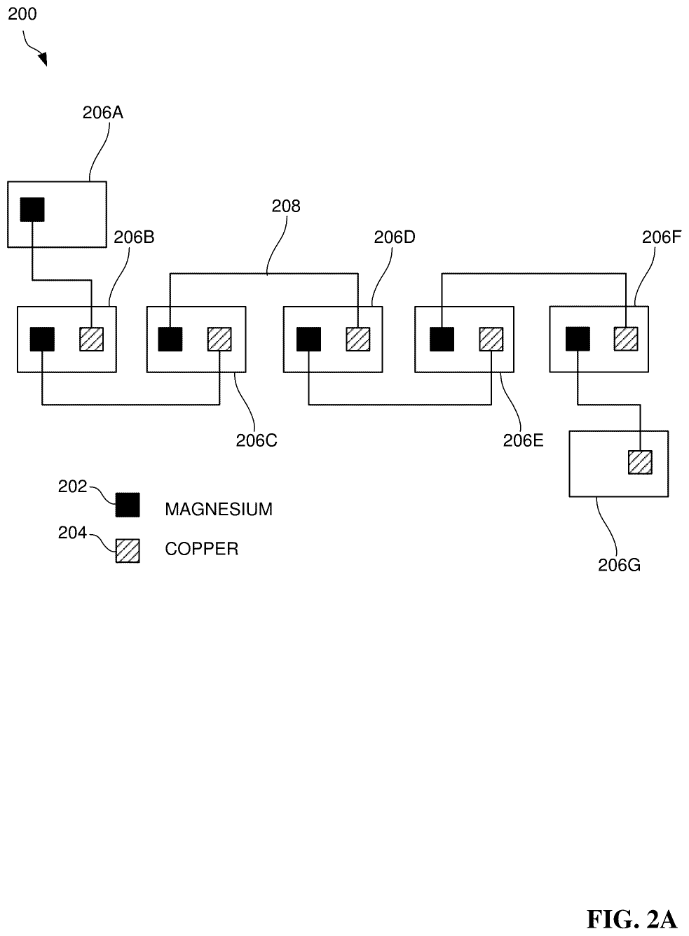

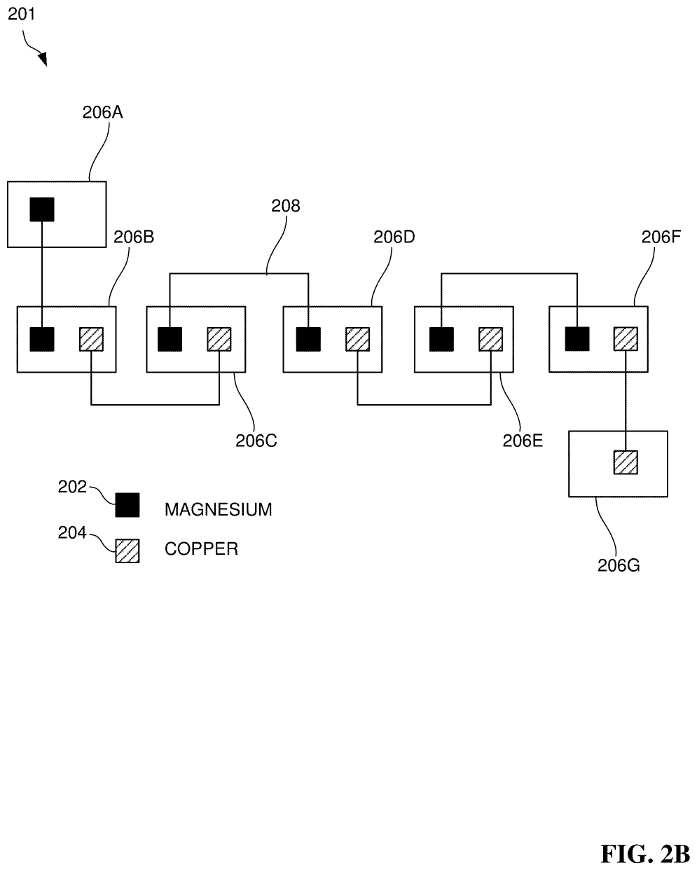

FIG. 2A depicts a schematic layout 200 of a battery configuration with multiple basic battery units connected in series, in accordance with one embodiment. As an option, the schematic layout 200 may be implemented in the context of any one or more of the embodiments set forth in any previous and/or subsequent figure(s) and/or description thereof. Of course, however, the schematic layout 200 may be implemented in the context of any desired environment. Further, the aforementioned definitions may equally apply to the description below.

The schematic layout 200 is of a battery configuration. The battery configuration includes a plurality of battery units 206A-206G, where battery units 206B-206F comprise a magnesium electrode 202 and a copper electrode 204, the battery unit 206A includes a magnesium electrode 202, and the battery unit 206G includes a copper electrode 204. In some aspects, the magnesium electrode 202 and the copper electrode 204 may be composed of a variety of materials, including but not limited to metals, alloys, or other conductive materials. The magnesium electrode 202 and the copper electrode 204 may be designed to facilitate the flow of electricity within the battery unit, contributing to the overall performance of the battery configuration 200. The choice of magnesium and copper for the electrodes may be based on their electrochemical properties, such as their standard electrode potentials, which can create a suitable voltage difference for energy generation. The magnesium electrode 202 may serve as the anode, while the copper electrode 204 may function as the cathode in the electrochemical cell. The specific dimensions and surface area of these electrodes may be optimized to enhance the battery's capacity and power output.

The battery units are interconnected in a series circuit, which may enhance the voltage output of the overall battery configuration. In some cases, the series circuit may involve the connection of the magnesium electrode 202 of one unit to the copper electrode 204 of the next unit. This series connection may be facilitated by wires, which may be composed of a variety of materials, including but not limited to metals, alloys, or other conductive materials. The wires may be designed to efficiently transmit electricity between the battery units, contributing to the overall performance of the battery configuration. The series configuration may allow for the additive effect of individual cell voltages, potentially enabling the battery system to achieve higher voltage outputs suitable for various applications. The choice of wire material and gauge may be optimized to minimize resistance and heat generation during operation, thereby improving the overall efficiency of the battery system.

In one embodiment, the wiring 208 may be used to connect the magnesium electrode 202 of one battery unit to a copper electrode 204 of another battery unit. In some cases, the wiring 208 may be composed of a variety of materials, including but not limited to metals, alloys, or other conductive materials. The wiring 208 may be designed to efficiently transmit electricity between the battery units, contributing to the overall performance of the battery configuration. The wiring 208 may incorporate features such as insulation coatings to prevent short circuits and enhance safety. In some implementations, the wiring 208 may be designed with flexibility to accommodate potential movement or expansion of the battery units during operation. The connections between the wiring 208 and the electrodes may be secured using various techniques such as soldering, welding, or mechanical fastening to ensure reliable electrical contact.

Additionally, the battery configuration may also include an activation mechanism, which may be configured to initiate the mixing of the organic material and the vinegar to create a biodegradable slurry. In some aspects, the activation mechanism may involve a physical or chemical process that triggers the interaction between the electrodes and the electrolyte. This activation mechanism may be designed to ensure the efficient operation of the battery configuration, contributing to its overall performance. For example, in various embodiments, the activation mechanism may be used to mix parts of an electrolyte solution (such as the vinegar and biomaterial such as fruit juice).

In various embodiments, the activation mechanism may involve a trigger that initiates interaction between a magnesium strip or powder and the bio-organic acid within the energy pod. This design may ensure that the reactive components remain separated until activation is desired, potentially extending shelf life and improving safety. The trigger mechanism may be engineered to provide uniform mixing upon activation.

In one embodiment, the activation mechanism may be implemented at the time of use of the battery, such that the electrolyte solution is not mixed until the battery is needed to be used. Further, a biomaterial based electrolyte may be particularly prone to oxidize, which may degrade performance of the battery. Thus, the battery unit may be configured such that the battery is a closed system assembly, and the electrolyte is mixed via the activation mechanism without exposing the electrolyte to air (which may thereby increase the oxidation process). As such, the electrolyte may remain in a closed system environment which may be configured to minimize the effects of oxidation. This configuration could potentially extend the lifespan of the battery configuration, enhancing its overall performance and efficiency. The use of a vacuum configuration may also contribute to the safety of the battery configuration, as it may reduce the risk of electrical shorts or other potential hazards associated with the operation of the battery units. The activation mechanism may incorporate features such as breakable seals or compartments that separate the organic material and vinegar until activation is desired. In some implementations, the activation mechanism may include a mechanical agitator or mixer to ensure thorough blending of the electrolyte components upon activation.

In some embodiments, the battery units may be individually wrapped with an insulating material. This insulating material may be composed of a variety of materials, including but not limited to plastic or rubber. The insulating material may be designed to prevent leakage of the electrolyte and to enhance the safety and efficiency of the battery configuration. In some cases, the insulating material may also provide structural support to the basic battery units, contributing to the overall durability and robustness of the battery configuration. The insulating material may be selected based on its chemical resistance to the electrolyte components, its thermal properties to manage heat dissipation, and its ability to maintain integrity over the expected lifespan of the battery. In some implementations, the insulating material may incorporate multiple layers or composite structures to provide enhanced protection and performance characteristics. The wrapping process may be designed to create a hermetic seal around each battery unit, further protecting against moisture ingress and potential contamination.

FIG. 2B depicts a schematic layout 201 of a battery configuration with multiple basic battery units connected in parallel, in accordance with one embodiment. As an option, the schematic layout 201 may be implemented in the context of any one or more of the embodiments set forth in any previous and/or subsequent figure(s) and/or description thereof. Of course, however, the schematic layout 201 may be implemented in the context of any desired environment. Further, the aforementioned definitions may equally apply to the description below.

The schematic layout 201 is of a battery configuration. The battery configuration includes a plurality of battery units 206A-206G, where battery units 206B-206F comprise a magnesium electrode 202 and a copper electrode 204, the battery unit 206A includes a magnesium electrode 202, and the battery unit 206G includes a copper electrode 204. In some aspects, the magnesium electrode 202 and the copper electrode 204 may be composed of a variety of materials, including but not limited to metals, alloys, or other conductive materials. The magnesium electrode 202 and the copper electrode 204 may be designed to facilitate the flow of electricity within the battery unit, contributing to the overall performance of the battery configuration 201. The choice of magnesium for the anode (electrode 202) may be due to its high energy density, abundance, and relatively low cost. Magnesium also has a higher theoretical voltage and energy density compared to other commonly used anode materials. The copper electrode 204, serving as the cathode, may be selected for its excellent electrical conductivity, corrosion resistance, and compatibility with the electrolyte solution. The specific dimensions, surface area, and morphology of these electrodes may be optimized to maximize the battery's capacity, power output, and overall efficiency.

The battery units are interconnected in a parallel circuit, which may enhance the current output of the overall battery configuration. In some cases, the parallel circuit may involve the connection of the magnesium electrode 202 of one unit to the magnesium electrode 202 the next unit, and the copper electrode 204 of one unit may be connected to the copper electrode 204 of the next unit. This parallel connection may be facilitated by wires, which may be composed of a variety of materials, including but not limited to metals, alloys, or other conductive materials. The wires may be designed to efficiently transmit electricity between the battery units, contributing to the overall performance of the battery configuration. The parallel configuration allows for the summation of currents from individual cells, potentially increasing the overall current capacity of the battery system. This arrangement may be particularly beneficial for applications requiring high current output, such as power tools or electric vehicles. The parallel connection may also provide redundancy, as the failure of a single cell may not significantly impact the overall performance of the battery system. In some implementations, the parallel configuration may incorporate load-balancing mechanisms to ensure even current distribution among the battery units, potentially extending the overall lifespan of the battery system.

In one embodiment, the wiring 208 may be used to connect the magnesium electrode 202 of one battery unit to the magnesium electrode 202 of the next unit, and the copper electrode 204 of one battery unit may be connected to the copper electrode 204 of the next unit. In some cases, the wiring 208 may be composed of a variety of materials, including but not limited to metals, alloys, or other conductive materials. The wiring 208 may be designed to efficiently transmit electricity between the battery units, contributing to the overall performance of the battery configuration. The activated mechanism may operate in a manner similar to that described in the context of FIG. 2A.

The wiring 208 may be designed with specific cross-sectional areas to handle the expected current flow without significant voltage drop or heat generation. In some implementations, the wiring 208 may incorporate smart features such as embedded sensors to monitor current flow, temperature, or other parameters critical to battery performance and safety. The connections between the wiring 208 and the electrodes may be designed for durability and resistance to corrosion, potentially using techniques such as ultrasonic welding or conductive adhesives. In advanced configurations, the wiring 208 may be integrated into a flexible or rigid circuit board that also incorporates control and monitoring electronics, potentially reducing the overall complexity and size of the battery system.

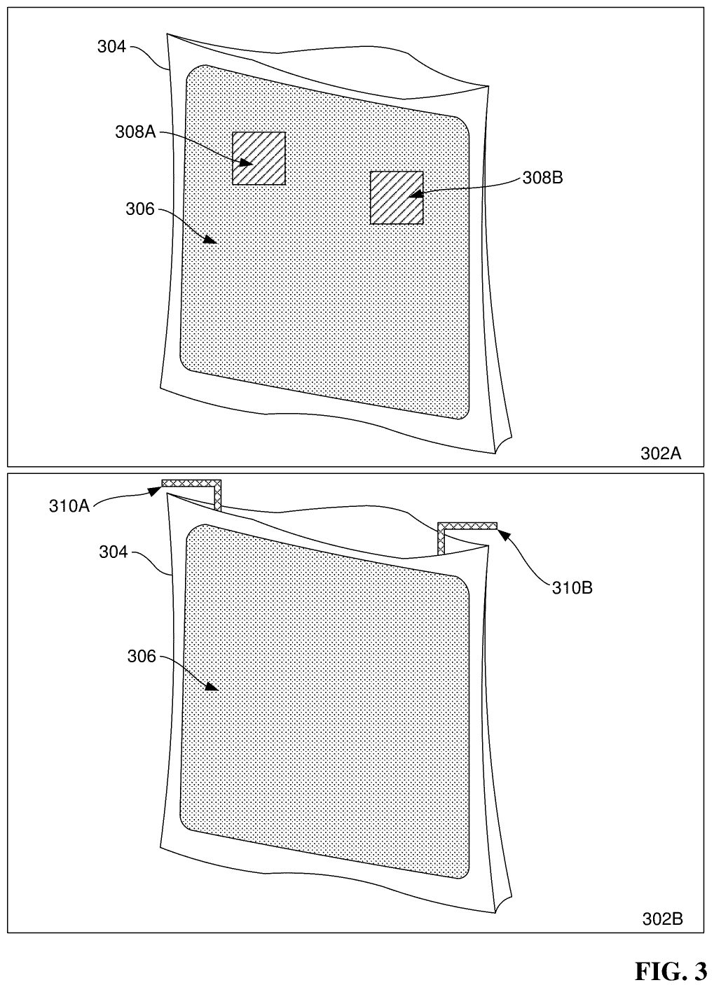

FIG. 3 illustrates two views 302A and 302B of a component of the innovative battery design, highlighting the cell pouch, slurry mixture, and electrodes, in accordance with one embodiment. As an option, the two views 302A and 302B may be implemented in the context of any one or more of the embodiments set forth in any previous and/or subsequent figure(s) and/or description thereof. Of course, however, the two views 302A and 302B may be implemented in the context of any desired environment. Further, the aforementioned definitions may equally apply to the description below.

As shown, the first configuration 302A shows a cell pouch 304 with a slurry mixture 306. The cell pouch 304 may be composed of a variety of materials, including but not limited to organic materials, biodegradable plastics, or other environmentally friendly materials. The cell pouch 304 may be designed to degrade naturally over time, reducing the environmental impact of the battery unit. The cell pouch 304 may be engineered with varying thicknesses and permeability characteristics to optimize the containment of the slurry mixture 306 while allowing for controlled biodegradation. In some implementations, the cell pouch 304 may incorporate multiple layers, each serving a specific function such as moisture barrier, structural support, or controlled degradation. The design of the cell pouch 304 may also consider factors such as tensile strength, puncture resistance, and thermal stability to ensure reliable performance across a range of operating conditions.

Within the cell pouch 304, there are two distinct sections, the first electrode 308A and the second electrode 308B, which are shaded differently. In some aspects, the first electrode 308A and the second electrode 308B may be composed of a variety of materials, including but not limited to metals, alloys, or other conductive materials. The first electrode 308A and the second electrode 308B may be designed to facilitate the flow of electricity within the battery unit, contributing to the overall performance of the battery configuration. The configuration of the first electrode 308A and the second electrode 308B may correspond with the configuration of FIG. 2A or FIG. 2B (the magnesium electrode 202 and the copper electrode 204) as one example. The electrode materials may be selected based on their electrochemical properties, corrosion resistance, and compatibility with the slurry mixture 306. In some cases, the electrodes may be treated with surface modifications or coatings to enhance their performance or longevity. The geometry and surface area of the electrodes may be optimized to maximize the contact with the slurry mixture 306, potentially incorporating features such as porous structures or nanoparticle coatings to increase the effective surface area.

The second configuration 302B presents a similar cell pouch 304 with the same slurry mixture 306. This view includes additional elements exiting the structure, labeled as first electrode wiring 310A and second electrode wiring 310B. These elements may serve as attachments or connectors, which might be used for linking the battery unit to other components or for facilitating the activation/triggering mechanism. In some cases, the first electrode wiring 310A and the second electrode wiring 310B may be composed of a variety of materials, including but not limited to metals, alloys, or other conductive materials.

The first electrode wiring 310A and the second electrode wiring 310B may be designed to efficiently transmit electricity between the battery units, contributing to the overall performance of the battery configuration. The wiring may be designed with specific cross-sectional areas and geometries to minimize resistance and heat generation. In some implementations, the wiring may incorporate strain relief features or flexible sections to accommodate potential movement or thermal expansion within the battery assembly. The connection points between the wiring and electrodes may be engineered for durability and resistance to corrosion, potentially utilizing techniques such as ultrasonic welding or conductive adhesives.

As such, the first electrode 308A and the second electrode 308B may represent a first configuration where electrode patches are placed on or within the covering of the cell pouch 304. In one embodiment, wiring may be attached to such electrodes (for series or parallel circuit configuration).

Alternatively, the first electrode wiring 310A and the second electrode wiring 310B may represent a second configuration where electric wiring is configured to be integrated directly within the cell pouch 304. In one embodiment, the first electrode wiring 310A and the second electrode wiring 310B may include electric terminals which may be connected to wiring (for series or parallel circuit configuration). The integration of wiring within the cell pouch 304 may involve advanced manufacturing techniques such as printed electronics or embedded conductive pathways. This integrated approach may offer benefits such as reduced assembly complexity, improved sealing against electrolyte leakage, and potentially enhanced durability. The design of the integrated wiring may also consider factors such as thermal management and electromagnetic shielding to optimize overall battery performance.

In some embodiments, the electrolyte of the slurry mixture 306 may be composed of a biodegradable organic material and vinegar. In one embodiment, the slurry mixture 306 may comprise a 1:1 ratio of organic material and vinegar. The organic material in the slurry mixture 306 may be selected from a variety of sources, including but not limited to lemon zest, banana, berries, orange zest, apples, grapes, and pineapple. In some cases, the slurry mixture 306 may undergo a bacterial decomposition process, which could potentially enhance the electrical potential of the battery unit. This use of biodegradable and non-toxic materials underscores the environmental friendliness of the battery design. The composition of the slurry mixture 306 may be further optimized by adjusting factors such as particle size distribution, viscosity, and ionic concentration to enhance conductivity and energy storage capacity. In some implementations, additives may be incorporated into the slurry mixture 306 to improve stability, extend shelf life, or enhance specific performance characteristics. The bacterial decomposition process may be carefully controlled through the selection of specific microbial strains or the addition of enzymes to optimize the generation of electrochemically active compounds.

In various embodiments, the use of vinegar as a key component may extend the shelf life of unused energy pods to more than one year (or another predetermined time length). This extended shelf life may provide advantages in terms of storage, distribution, and overall practicality compared to some conventional battery types.

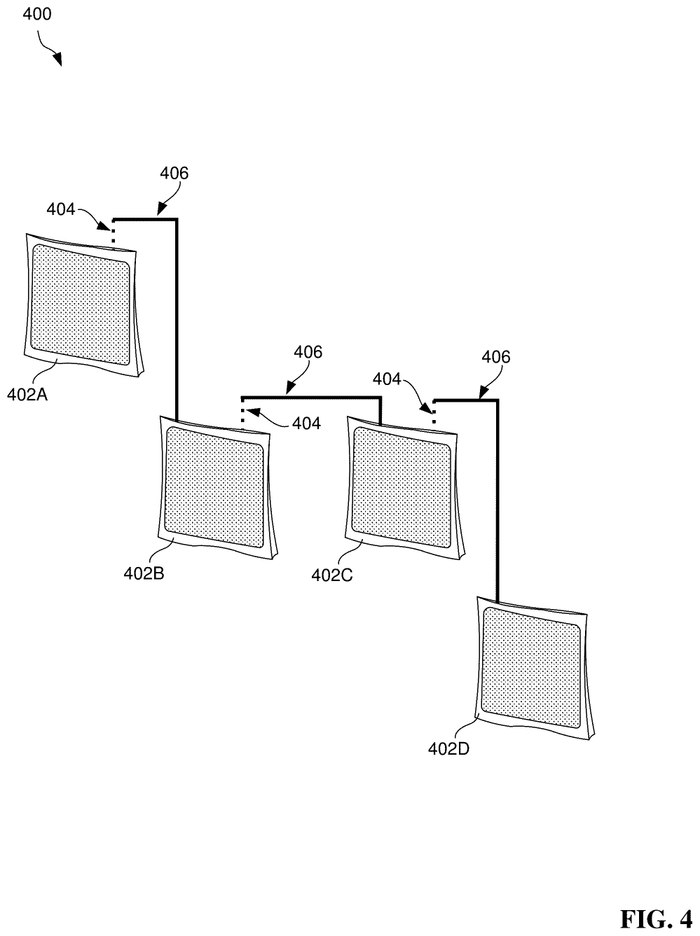

FIG. 4 illustrates a battery configuration 400 with multiple basic battery units and their interconnections, in accordance with one embodiment. As an option, the battery configuration 400 may be implemented in the context of any one or more of the embodiments set forth in any previous and/or subsequent figure(s) and/or description thereof. Of course, however, the battery configuration 400 may be implemented in the context of any desired environment. Further, the aforementioned definitions may equally apply to the description below.

As shown, the battery configuration 400 is of four basic battery units, denoted as first basic battery unit 402A, second basic battery unit 402B, third basic battery unit 402C, and fourth basic battery unit 402D. The units are interconnected by lines labeled as magnesium wiring 404 and copper wiring 406, which represent electrical connections. Each basic battery unit may contain its own set of electrodes, electrolyte, and activation mechanism. The arrangement of these units in a vertical stack may allow for efficient space utilization and heat dissipation. The modular design of these units may facilitate easy replacement or maintenance of individual components without affecting the entire battery system. It is to be appreciated that any number of battery units may be connected and that the display of four battery units is not to be construed as limiting in any manner.

In some aspects, the magnesium wiring 404 may connect the positive and negative terminals of adjacent units, indicating a series connection to amplify the voltage output. This series connection may be facilitated by the magnesium wiring 404, which may be designed to efficiently transmit electricity between the battery units, contributing to the overall performance of the battery configuration 400. The magnesium wiring 404 may be selected for its low electrical resistance and compatibility with the magnesium electrodes. The thickness and insulation of the magnesium wiring 404 may be optimized to minimize power loss and ensure safe operation at the expected voltage levels. In some implementations, the magnesium wiring 404 may incorporate strain relief features to accommodate thermal expansion and contraction during charge-discharge cycles.

In some cases, the copper wiring 406 may be used for output connections from the series configuration. The copper wiring 406 may be designed to efficiently transmit electricity from the battery units to the device they power, contributing to the overall performance of the battery configuration 400. The copper wiring 406 may be chosen for its excellent conductivity and corrosion resistance. The gauge of the copper wiring 406 may be selected based on the maximum expected current output of the battery configuration. In some designs, the copper wiring 406 may include integrated current sensing capabilities to monitor the battery's performance and detect potential issues.

In other embodiments, the basic battery units may be arranged in a parallel circuit (not shown) to amplify the current output. This parallel connection may be facilitated by the copper wiring 406, which may be designed to efficiently transmit electricity between the battery units, contributing to the overall performance of the battery configuration 400. In a parallel configuration, the copper wiring 406 may need to handle higher current loads compared to the series configuration. The connection points between the copper wiring 406 and the battery units may incorporate additional reinforcement or heat dissipation measures to manage the increased current flow. The parallel arrangement may also include balancing circuits to ensure even current distribution among the battery units, potentially extending the overall lifespan of the battery system.

It is to be appreciated that FIG. 4 displays the modular and scalable nature of the battery design. As such, the electric output of the system may be dependent on the number of battery units involved (for example in series or parallel configuration). This modularity may allow for customization of the battery system to meet specific voltage or current requirements for different applications. The scalable design may also facilitate future upgrades or capacity expansions by simply adding more battery units to the existing configuration. In some implementations, the battery system may incorporate smart management systems that can dynamically reconfigure the connections between units to optimize performance based on real-time power demands or individual unit health.

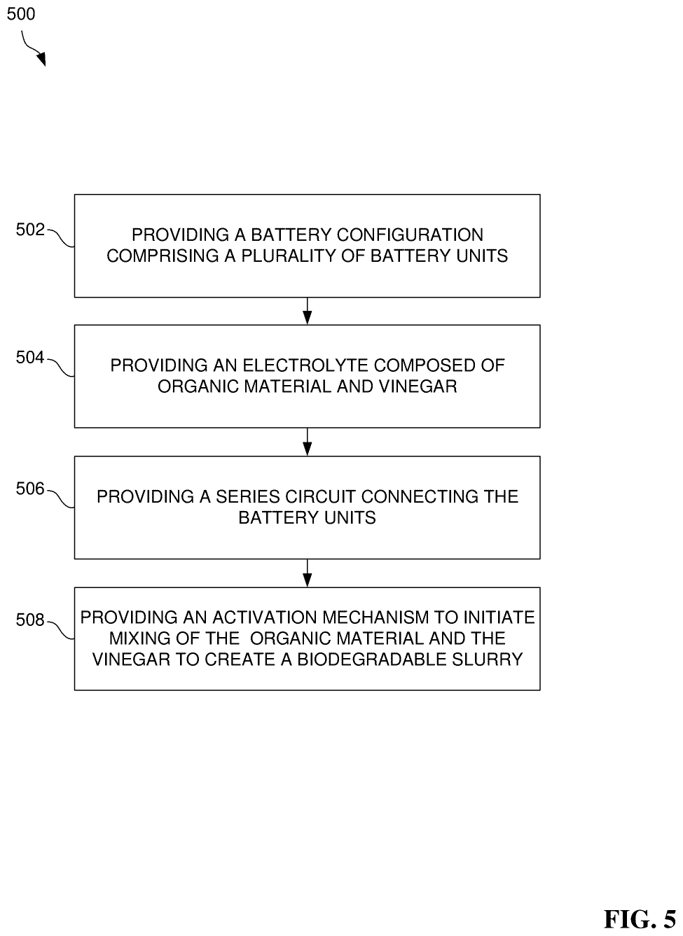

FIG. 5 illustrates a flowchart 500 of a battery creation process, emphasizing the provision of a battery configuration and the configuration of a biodegradable electrolyte, in accordance with one embodiment. As an option, the flowchart 500 may be implemented in the context of any one or more of the embodiments set forth in any previous and/or subsequent figure(s) and/or description thereof. Of course, however, the flowchart 500 may be implemented in the context of any desired environment. Further, the aforementioned definitions may equally apply to the description below.

At step 502, a battery configuration is provided comprising a plurality of battery units. At step 504, an electrolyte is provided composed of organic material and vinegar. At step 506, a series circuit is provided connecting the battery units. Additionally, at step 508, an activation mechanism is provided to initiate mixing of the organic material and the vinegar to create a biodegradable slurry.

In various embodiments, the battery units may be designed with standardized dimensions and connection interfaces to facilitate easy assembly and replacement. The organic material for the electrolyte may be sourced from local waste streams, potentially reducing costs and enhancing sustainability. The series circuit may incorporate smart connectors that can detect and bypass faulty units, enhancing overall system reliability. The activation mechanism may include a user-friendly interface, such as a simple twist or pull action, to initiate the mixing process safely and efficiently.

In various embodiments, the anode and cathode of the battery may be composed of a variety of materials, including but not limited to metals, alloys, or other conductive materials. In some aspects, the anode may be a magnesium electrode and the cathode may be a copper electrode. The biodegradable electrolyte may be composed of a biodegradable slurry mixture of organic material and vinegar, as described previously. The magnesium anode may be alloyed with small amounts of other elements to enhance its corrosion resistance and electrical properties. The copper cathode may be treated with a nano-textured surface to increase its effective surface area and improve reaction kinetics. The organic material in the electrolyte may be pre-treated to optimize its ionic conductivity and compatibility with the electrode materials.

Additionally, in other embodiments, the electrolyte may be configured to be nontoxic and biodegradable. This involves specifying that the electrolyte is composed of biomaterial, which may include a variety of organic materials such as fruit peels, vegetable scraps, and/or other types of food waste. In some cases, the biomaterial may be processed into a slurry, which may then be mixed with vinegar to form the biodegradable slurry electrolyte. The use of biomaterial in the electrolyte composition underscores the environmental friendliness of the battery design, as the electrolyte may decompose naturally at the end of its lifecycle, reducing the environmental impact of the battery configuration.

The processing of biomaterial into a slurry may involve techniques such as ultrasonic homogenization to ensure uniform particle size and distribution. The vinegar used in the electrolyte may be specially formulated to optimize its pH and ionic strength for maximum electrical conductivity. The decomposition process of the electrolyte may be designed to occur within a specific timeframe, allowing for predictable end-of-life management.

In some aspects, the battery creation process flowchart 500 may also include additional steps, such as assembling the battery units into a series or parallel circuit, wrapping the battery units with an insulating material, and/or activating the battery units using an activation mechanism. These additional steps may be designed to enhance the performance and efficiency of the battery configuration, contributing to its overall functionality and versatility. The assembly process may utilize automated systems for precise and consistent connections between units. The insulating material may be a biodegradable polymer that also acts as a thermal management layer, regulating the battery's operating temperature. The activation mechanism may incorporate a safety feature that prevents accidental activation during transport or storage.

Overall, the battery creation process flowchart 500 provides a visual representation of the steps involved in creating the innovative battery design described in the present disclosure. This process emphasizes the use of biodegradable and nontoxic materials in the electrolyte composition, highlighting the environmental sustainability of the battery design. The flowchart may be integrated into a digital manufacturing system, allowing for real-time monitoring and optimization of each step in the production process. The use of biodegradable and nontoxic materials may extend beyond the electrolyte to include other components such as separators and casings, further enhancing the battery's overall environmental profile. The process may also incorporate quality control checkpoints at each stage to ensure consistency and reliability in the final product.

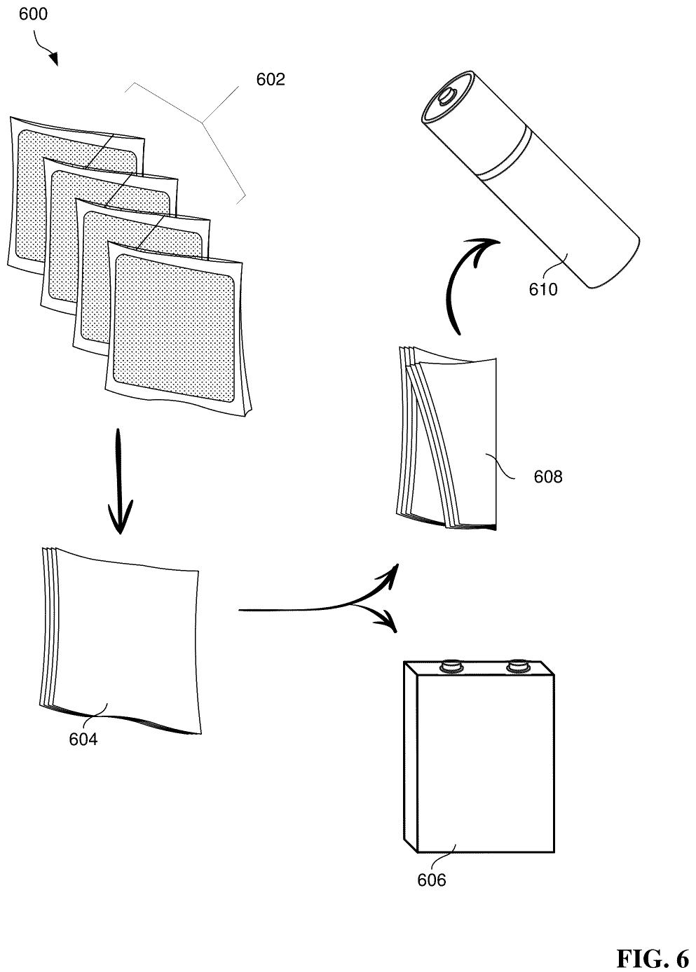

FIG. 6 illustrates a various configurations 600 of a battery design, showcasing the versatility and modularity of the design, in accordance with one embodiment. As an option, the various configurations 600 may be implemented in the context of any one or more of the embodiments set forth in any previous and/or subsequent figure(s) and/or description thereof. Of course, however, the various configurations 600 may be implemented in the context of any desired environment. Further, the aforementioned definitions may equally apply to the description below.

As shown, the various configurations 600 are of a battery design. As shown, the various configurations 600 includes a series of cell pouches 602 stacked together. In some aspects, the series of cell pouches 602 may be composed of a variety of materials, including but not limited to organic materials, biodegradable plastics, or other environmentally friendly materials. The series of cell pouches 602 may be designed to degrade naturally over time, reducing the environmental impact of the battery unit. The cell pouches 602 may be engineered with multiple layers, each serving a specific function such as electrolyte containment, moisture barrier, or structural support. The materials used for the cell pouches 602 may be selected based on their compatibility with the electrolyte, their ability to withstand the expected operating conditions, and their rate of biodegradation. In some implementations, the cell pouches 602 may incorporate nano-materials or bio-based polymers to enhance their performance and environmental properties.

An aggregate assembly 604 is depicted, representing a combination of multiple cell pouches 602. The number of cell pouches 602 stacked together to form an aggregate assembly 604 may be dependent on the energy output needs. For example, a smaller battery may include fewer cell pouches, whereas a larger battery (with greater capacity needs) may include many more cell pouches. The stacking arrangement of the cell pouches 602 in the aggregate assembly 604 may be optimized to maximize energy density while ensuring efficient heat dissipation. In some designs, the aggregate assembly 604 may incorporate interleaving layers of thermally conductive, yet electrically insulating materials to manage temperature distribution. The connections between individual cell pouches 602 within the aggregate assembly 604 may be designed for both electrical efficiency and mechanical stability, potentially using flexible connectors that can accommodate slight movements or expansions during operation.

Next, the aggregate assembly 604 may be folded and wound via step 608 to result in a cylindrical cell 610. In some aspects, the cylindrical cell 610 may be composed of a variety of materials, including but not limited to organic materials, biodegradable plastics, or other environmentally friendly materials. The cylindrical cell 610 may be designed to degrade naturally over time, reducing the environmental impact of the battery unit. Further, the aggregate assembly may be created specifically for the type of intended use battery (long term voltage requirements, high energy output, etc.). Additionally, given the electrolyte slurry is in liquid (or semi-liquid form such as gel), the contents of the cell pouch 602 may be easily wound into cylindrical cell 610 form. The winding process may be carefully controlled to ensure uniform tension and alignment of the layers, which can impact the overall performance and longevity of the cylindrical cell 610. The cylindrical form factor may offer advantages in terms of structural integrity and volumetric efficiency. In some implementations, the cylindrical cell 610 may include a central mandrel or core that serves both as a structural support and as a channel for thermal management.

Additionally, another configuration includes a prismatic cell 606 is depicted, representing an alternative form factor for the biomaterial-based battery. In some aspects, the prismatic cell 606 may be composed of a variety of materials, including but not limited to organic materials, biodegradable plastics, or other environmentally friendly materials. The prismatic cell 606 may be designed to degrade naturally over time, reducing the environmental impact of the battery unit. The prismatic form factor may offer advantages in terms of space utilization and cooling efficiency in certain applications. The internal structure of the prismatic cell 606 may be designed with multiple compartments or sections to optimize the distribution of active materials and manage internal pressures. In some designs, the prismatic cell 606 may incorporate structural reinforcements along its edges or corners to enhance durability while maintaining its overall biodegradability.

The arrows connecting these components indicate the flow or assembly process, demonstrating the modular and versatile nature of the battery design. In some cases, the assembly process may involve the stacking of the series of cell pouches 602, the creation of the aggregate assembly 604, the rolling/winding of the aggregate assembly 604 via step 608 resulting in the formation of the cylindrical cell 610, and the assembly of the prismatic cell 606. This assembly process may be designed to be scalable and customizable, allowing for the creation of battery units with varying power outputs to suit different applications. The modular nature of the design may enable automated assembly processes, potentially reducing manufacturing costs and improving consistency. The assembly process may also incorporate in-line quality control measures, such as impedance testing or thermal imaging, to ensure each component meets performance standards before final assembly. In some implementations, the assembly process may be designed to be reversible, facilitating casier recycling or refurbishment of battery components at the end of their lifecycle.

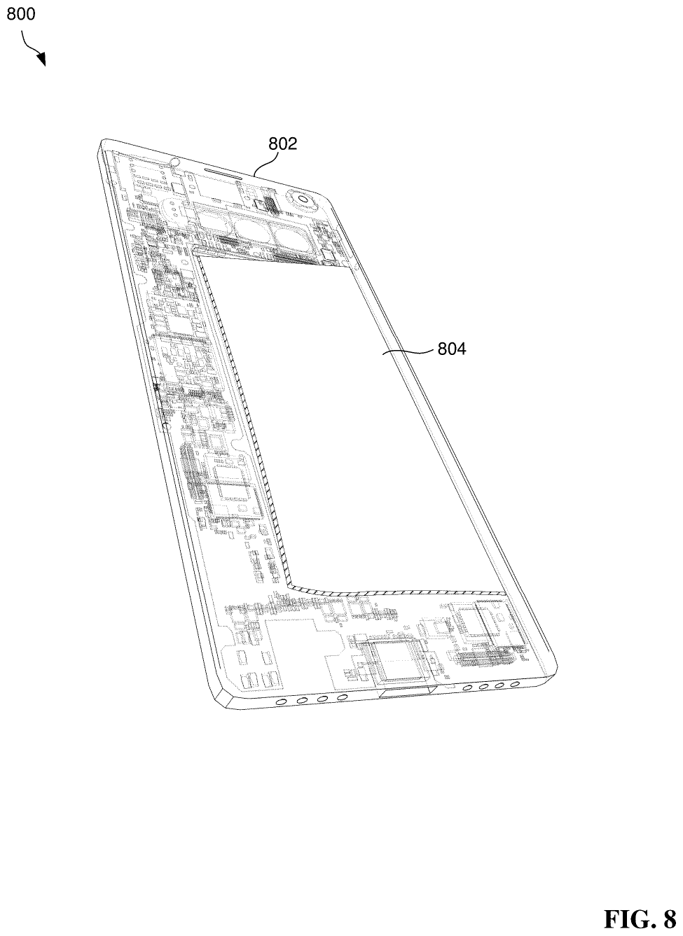

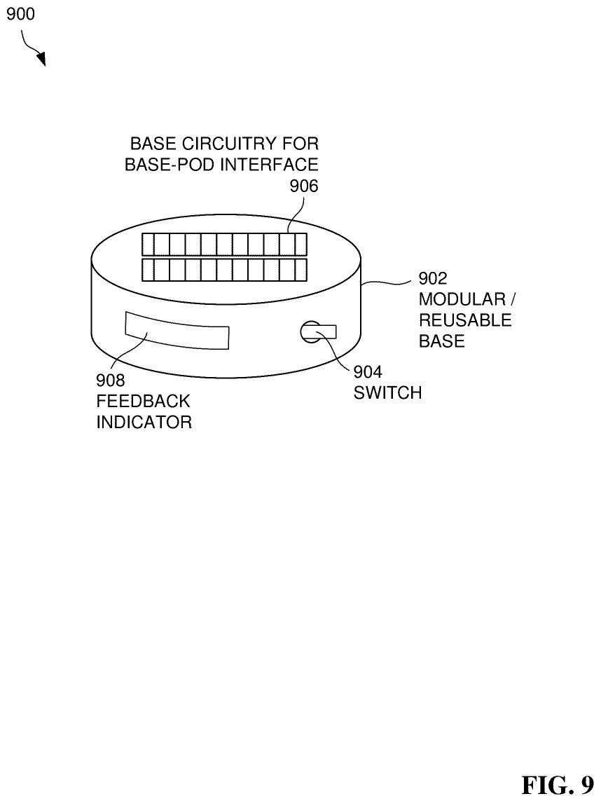

Further, the various configurations 600 illustrate the versatility and adaptability of the battery design, showcasing how the basic cell pouch components can be transformed into different form factors to suit various applications. These configurations can be further enhanced by incorporating the modular pod-type design described in subsequent figures. For instance, the cylindrical cell 610 or prismatic cell 606 could be designed as removable energy pods that interface with a modular base, as shown in FIGS. 8 and 9 and beyond. This integration would allow for easy replacement and customization of the battery system while maintaining the benefits of the biodegradable components. The aggregate assembly 604 could be structured to include multiple smaller, interchangeable pods within a larger housing, enabling users to replace individual sections as needed. By combining the flexible assembly methods shown here with the modular pod concept, the battery system can offer even greater versatility, allowing for seamless integration into a wide range of devices and applications while preserving its core principles of sustainability and customizable power delivery.

The configurations illustrated in FIG. 6 address significant limitations of prior art systems, which have struggled to achieve sufficient power density in small form factor biodegradable batteries. Conventional biomaterial-based batteries often require large volumes to generate meaningful power outputs, making them impractical for many modern applications. However, the arrangement used within the present description overcomes these challenges.

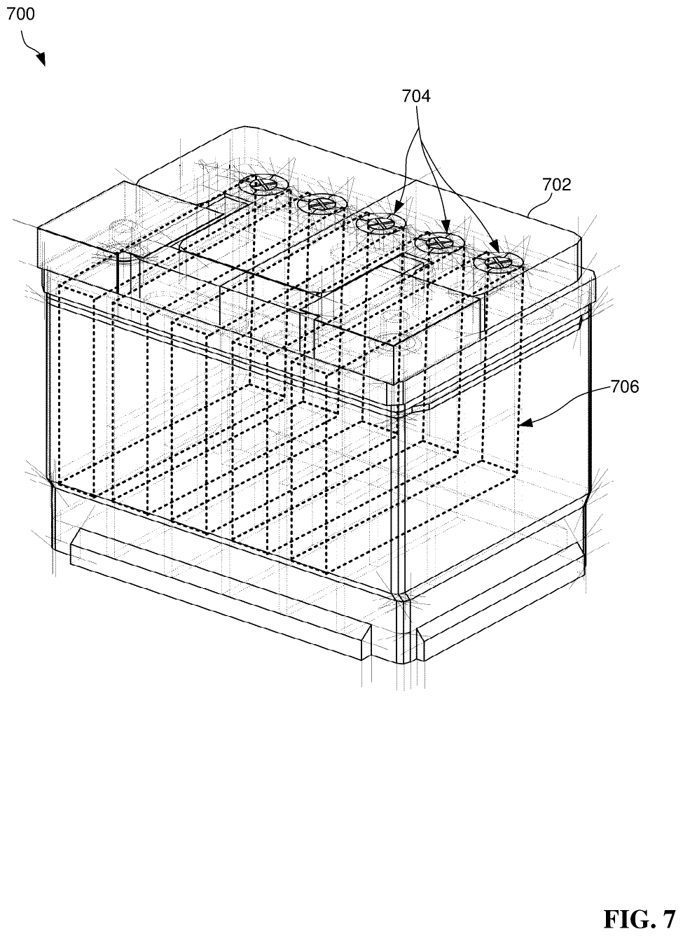

FIG. 7 illustrates an isometric view 700 of a battery unit, in accordance with one embodiment. As an option, the isometric view 700 may be implemented in the context of any one or more of the embodiments set forth in any previous and/or subsequent figure(s) and/or description thereof. Of course, however, the isometric view 700 may be implemented in the context of any desired environment. Further, the aforementioned definitions may equally apply to the description below.

As shown, isometric view 700 of a battery unit is encased in a rectangular housing 702, which provides structural support and protection for the internal components. The rectangular housing 702 may be composed of a variety of materials, including but not limited to plastic, metal, or a composite material. In some cases, the rectangular housing 702 may be designed to be robust and durable, capable of withstanding the rigors of everyday use. The housing may incorporate reinforced corners and impact-resistant materials to enhance durability. Additionally, the rectangular housing 702 may feature a modular design that allows for easy access to internal components for maintenance or replacement. The surface of the housing may be treated with a protective coating to resist corrosion and environmental degradation, further extending its lifespan.

The top section of the isometric view 700 of a battery unit features multiple circular terminals 704, which are evenly spaced and aligned in a row. These circular terminals 704 may serve as points for electrical connections, facilitating the flow of electricity from the battery unit to the device it powers. In some aspects, the circular terminals 704 may be designed to interface with corresponding connectors in the device, ensuring efficient electrical communication. The multiple circular terminals 704 may be each connected directly to an aggregate assembly (such as the aggregate assembly 604) comprising multiple cell pouches containing the biomaterial-based electrolyte. The terminals may be made of highly conductive materials such as gold-plated copper to minimize electrical resistance. They may also incorporate safety features like recessed designs or protective covers to prevent accidental short circuits. The arrangement of terminals may follow a standardized pattern to ensure compatibility with a wide range of devices.

Inside the rectangular housing 702 are biodegradable cell units 706. These biodegradable cell units 706 may be composed of a variety of materials, including but not limited to organic materials, biodegradable plastics, or other environmentally friendly materials. In some cases, the biodegradable cell units 706 may be designed to degrade naturally over time, reducing the environmental impact of the battery unit. The biodegradable materials may be engineered to break down into non-toxic components when exposed to specific environmental conditions, such as certain soil bacteria or UV light. The cell units may also incorporate sacrificial anodes or other corrosion protection methods to ensure they maintain their integrity during the battery's operational life while still allowing for eventual biodegradation.

It is to be appreciated that the biodegradable cell units 706 may coincide with that which has been discussed in former figures, including FIG. 6 and others.

The arrangement of these elements within isometric view 700 of a battery unit highlights its modular and scalable design. In some aspects, the battery unit may be designed to be scalable, allowing for the addition or removal of biodegradable cell units 706 to adjust the power output of the battery unit. This scalability may allow the battery unit to be customized for different applications, such as electric vehicles, consumer electronics, and/or home power wall generators. The modular design may incorporate standardized connectors and interfaces between cell units, enabling hot-swapping capabilities for continuous operation in critical applications. The scalability may extend to the control systems, with intelligent power management modules that can automatically optimize performance based on the number and configuration of installed cell units.

In some cases, the basic battery units (such as the biodegradable cell units 706) within isometric view 700 of a battery unit may be configured to be replaceable. This could allow for the replacement of depleted or damaged individual biodegradable cell units 706 without the need to replace the whole battery unit, potentially extending the lifespan of the battery unit and reducing waste. The replacement process may be designed to be user-friendly, with tool-less access panels and color-coded connectors to facilitate easy maintenance. Each cell unit may contain its own diagnostic system, capable of reporting its health status and predicting when replacement might be necessary, enabling proactive maintenance schedules.

In other cases, the biodegradable cell units 706 within isometric view 700 of a battery unit may be configured to be rechargeable. This could allow the battery unit to be replenished via a charging mechanism, providing a sustainable and environmentally friendly energy solution. For example, each unit of the biodegradable cell units 706 may include a port for discarding the current reservoir of electrolyte solution, and introducing fresh electrolyte with not yet used biomaterial. The recharging system may incorporate advanced filtration mechanisms to purify and recycle a portion of the used electrolyte, reducing waste and extending the time between full electrolyte replacements. The charging process may be optimized through machine learning algorithms that adapt to usage patterns and environmental conditions to maximize efficiency and longevity.

In some aspects, the basic battery units within isometric view 700 of a battery unit may be configured to be energy dense. This could allow the battery unit to store a large amount of energy in a relatively small volume, making it an efficient power source for various applications. The energy density may be enhanced through the use of advanced electrode materials and optimized cell geometries. The battery design may incorporate multi-layered structures or 3D electrode configurations to maximize the surface area for electrochemical reactions within a compact volume. Additionally, the battery management system may employ charge/discharge algorithms to extract the maximum available energy while preserving the long-term health of the cells.

FIG. 8 illustrates an internal view 800 of an electronic device, highlighting the integration of the biodegradable cell battery within the device, in accordance with one embodiment. As an option, the internal view 800 may be implemented in the context of any one or more of the embodiments set forth in any previous and/or subsequent figure(s) and/or description thereof. Of course, however, the internal view 800 may be implemented in the context of any desired environment. Further, the aforementioned definitions may equally apply to the description below.

As shown, the internal view 800 is of an electronic device, specifically a smartphone 802. The smartphone 802 is shown to include a biodegradable cell battery 804, which is located within the device. In some aspects, the biodegradable cell battery 804 may occupy a substantial portion of the internal space of the smartphone 802. This could be advantageous in terms of maximizing the energy storage capacity of the device, thereby potentially enhancing its operational longevity between charging cycles. The biodegradable cell battery 804 may be custom-designed to fit the specific internal dimensions of the smartphone 802, optimizing space utilization while maintaining structural integrity. In some implementations, the biodegradable cell battery 804 may incorporate a flexible design, allowing it to conform to curved or irregular spaces within the smartphone 802, further maximizing energy storage capacity.

In some cases, the biodegradable cell battery 804 may be designed to interface seamlessly with the other electronic components of the smartphone 802. This may involve the use of specific connectors or interfaces that allow for efficient electrical communication between the biodegradable cell battery 804 and the other components of the smartphone 802. These connectors may be designed to be compact yet robust, capable of handling the power requirements of modern smartphones while maintaining reliability over numerous charge cycles. The interface may also include smart circuitry that enables real-time monitoring of battery health, charge status, and power consumption patterns. This data could be used by the smartphone's operating system to optimize power management and provide accurate battery life estimates to the user. Additionally, the interface may incorporate safety features such as thermal management, and short circuit prevention to ensure safe operation within the confined space of the smartphone 802.

In various embodiments, safety features may include plastic sealants, cotton barriers, or specialized foams to separate the electrodes. These materials may help prevent short circuits and ensure safe operation of the energy pods. The modular base may also incorporate protective circuitry to prevent overcharging.

In some embodiments, the biodegradable cell battery 804 may be replaceable, allowing for the possibility of swapping out a depleted battery for a fully charged one. This could provide a convenient way for users to extend the operational time of their device without needing to plug it into a power source. The replacement mechanism may be designed to be user-friendly, potentially featuring a tool-less removal system that allows for quick and easy battery swaps. This replaceable design could also facilitate casier recycling or composting of depleted batteries, aligning with the eco-friendly nature of the biodegradable cell battery 804. The smartphone 802 may include a secure locking mechanism to ensure the replaceable battery remains firmly in place during normal use, while still allowing for easy removal when needed. Furthermore, the device may be programmed to recognize when a new battery has been inserted, automatically adjusting its power management settings to optimize performance for the fresh battery.

In other embodiments, the biodegradable cell battery 804 may be rechargeable, allowing it to be replenished via a replenishment mechanism integrated into the smartphone 802. This could provide a sustainable and environmentally friendly energy solution for powering the device (and reenergizing the battery).

Overall, the integration of the biodegradable cell battery 804 within an electronic device, such as a smartphone 802, underscores the potential applicability and versatility of the innovative battery design in real-world consumer electronics. This integration demonstrates how sustainable energy solutions can be seamlessly incorporated into everyday devices without sacrificing performance or user experience. The use of biodegradable materials in a high-tech application like smartphones could set a new standard for environmental responsibility in the electronics industry. Furthermore, this implementation could pave the way for the adoption of similar biodegradable power solutions in other consumer electronics, potentially revolutionizing the approach to energy storage across a wide range of devices. The success of this integration could also drive further research and development in the field of biodegradable electronics, leading to more comprehensive eco-friendly solutions in future device designs.

FIG. 9 illustrates a top view of a battery configuration 900, in accordance with one embodiment. As an option, the battery configuration 900 may be implemented in the context of any one or more of the embodiments set forth in any previous and/or subsequent Figures and/or description thereof. Of course, however, the battery configuration 900 may be implemented in the context of any desired environment. Further, the aforementioned definitions may equally apply to the description below.

The battery configuration 900 includes a modular base 902 having a circular form factor. The modular base 902 may serve as the foundation for the battery configuration 900, providing structural support and housing for various components. The circular design may offer advantages in terms of weight distribution and stability. In some implementations, the modular base 902 may incorporate a layered structure, with each layer serving specific functions such as power management, thermal regulation, or communication interfaces. The modular nature of the base may allow for easy upgrades or replacements of individual components without necessitating a complete system overhaul. It is to be noted that the circular form factor is merely one example of the form factor of the battery configuration. Of course, other form factors of any shape are feasible.

In various embodiments, heat dissipation in the modular base may be managed through various cooling mechanisms when multiple energy pods are connected. This may include passive cooling designs or active thermal management systems to maintain optimal operating temperatures across different power configurations.

In some cases, the modular base 902 may be constructed from durable materials such as reinforced plastics or lightweight metals, ensuring longevity and resistance to environmental factors. The circular design of the modular base 902 may allow for efficient space utilization and facilitate integration with other circular or cylindrical components. The materials used may be selected for their thermal properties, potentially incorporating heat-dissipating elements to manage temperature during operation. The surface of the modular base 902 may be treated with corrosion-resistant coatings to enhance durability in various environmental conditions. The circular form factor may also allow for the implementation of a rotating mechanism, potentially enabling dynamic reconfiguration of connected components. In other embodiments, the surface of the modular base 902 may be configured to be environmentally friendly such that it can be decompose naturally (such as in a landfill) after the power of the battery has been fully used and the unit has been discarded.

The modular base 902 contains base circuitry 906 for base-pod interface, which is arranged in a grid pattern on the upper surface of the modular base 902. The base circuitry 906 may facilitate electrical connections between the modular base 902 and other components of the battery configuration 900. This grid pattern may allow for multiple connection points, potentially enabling the simultaneous attachment of various energy storage or power management modules. The base circuitry 906 may incorporate redundant pathways to ensure continued functionality in case of individual connection failures.

In some cases, the base circuitry 906 may include conductive pathways, connection points, and control elements designed to manage power flow and communication between the modular base 902 and attached energy storage units. The grid pattern arrangement of the base circuitry 906 may allow for flexible positioning and connection of various components. The circuitry may include intelligent power routing capabilities, automatically optimizing the flow of energy based on the configuration and status of connected modules. Additionally, the base circuitry 906 may incorporate protection mechanisms such as overcurrent prevention and voltage regulation to ensure safe operation.

An activation switch 904 is positioned on one side of the modular base 902. The activation switch 904 may serve as a user interface element for controlling the operation of the battery configuration 900. This switch may be programmable, allowing users to customize its function based on specific use cases or preferences. The activation switch 904 may also serve as an emergency shut-off mechanism, capable of quickly disconnecting power in case of system malfunction or safety concerns. In one embodiment, the activation switch 904 may be used to activating agent to combine the two electrolytes in some manner.

In some cases, the activation switch 904 may be designed with tactile feedback mechanisms to provide users with confirmation of switch engagement. The positioning of the activation switch 904 on the side of the modular base 902 may allow for easy access while minimizing accidental activation. The switch may incorporate a multi-stage activation process, requiring a specific sequence of actions to fully engage, further reducing the risk of unintended activation. The area around the switch may be textured or colored differently to enhance visibility and tactile recognition.

A feedback indicator 908 is located on the opposite side of the modular base 902 from the activation switch 904. The feedback indicator 908 may provide visual or auditory information about the status of the battery configuration 900. This indicator may be capable of displaying multiple colors or patterns to convey a range of status information. In some implementations, the feedback indicator 908 may include haptic feedback capabilities, providing tactile alerts for important status changes or warnings.

In some cases, the feedback indicator 908 may utilize LED lights or a small display screen to communicate information such as battery charge level, operational status, or error conditions. The placement of the feedback indicator 908 opposite the activation switch 904 may create a balanced design and allow for clear visibility of status information. The indicator may be designed with adjustable brightness levels to ensure visibility in various lighting conditions while conserving power when full illumination is not necessary. Additionally, the feedback indicator 908 may be linked to a companion mobile app, allowing users to receive detailed status updates and notifications on their smartphones or other connected devices.

The circular design of the modular base 902 and the grid pattern arrangement of the base circuitry 906 exemplify a resolution to problems of flexibility and scalability in battery configurations. This design may allow for easy attachment and detachment of various energy storage components, potentially enabling customization of the battery system for different applications or power requirements.

In various embodiments, the modular base 902 may incorporate additional sensors or monitoring systems. These systems may track factors such as temperature, humidity, or usage patterns, potentially allowing for adaptive power management and enhanced battery longevity. Additionally, the base circuitry 906 may be designed with standardized connection interfaces. This standardization may allow for compatibility with a wide range of energy storage units from different manufacturers, potentially increasing the versatility and upgradability of the battery configuration 900. Further, the battery configuration 900 may include wireless communication capabilities integrated into the modular base 902. These capabilities may allow for remote monitoring, control, and diagnostics of the battery system, potentially enhancing user convenience and enabling advanced power management strategies.

Taking a step back, FIG. 9 illustrates an alternative form factor for the modular biodegradable battery system, presenting a core single unit energy pod that integrates multiple energy units into a cohesive structure. Unlike the configurations shown in FIG. 6, this design utilizes a modular base that houses and may be configured to interconnect several individual energy units. The modular base may be configured to allow for flexible internal connections between multiple energy units, enabling them to be configured in series or parallel arrangements as needed. This integrated approach provides a compact, self-contained energy pod that can deliver customizable power outputs while maintaining a consistent external form factor. This configuration demonstrates the versatility of the biodegradable battery system, showing how the core principles of modularity and biodegradability can be adapted into various form factors to suit different application requirements, from the stackable or windable designs of FIG. 6 to the present integrated circular pod format of FIG. 9. Further, the energy pods may be designed as individual containers housing magnesium and bio-organic acids, with an integrated activation mechanism to separate the two ingredients until power generation is required. This self-contained design may enhance portability and ease of use.

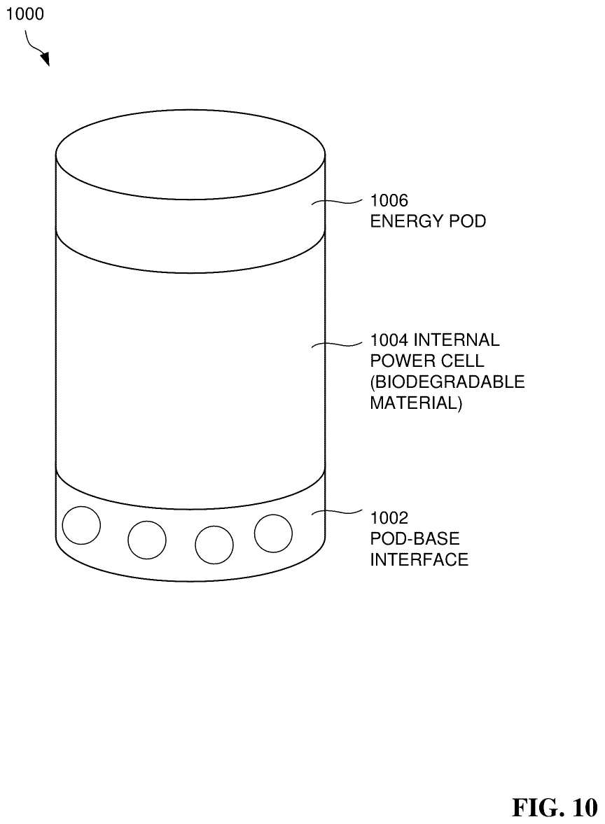

FIG. 10 illustrates an orthogonal view of a battery assembly 1000, in accordance with one embodiment. As an option, the battery assembly 1000 may be implemented in the context of any one or more of the embodiments set forth in any previous and/or subsequent Figures and/or description thereof. Of course, however, the battery assembly 1000 may be implemented in the context of any desired environment. Further, the aforementioned definitions may equally apply to the description below.

The battery assembly 1000 comprises a cylindrical structure with multiple distinct sections arranged vertically. The battery assembly 1000 includes an interface section 1002, a power cell 1004, and an energy pod 1006. This cylindrical design may offer advantages in terms of structural integrity, efficient space utilization, and ease of manufacturing. The vertical arrangement of components may allow for optimized internal connections and simplified assembly processes. The cylindrical form factor may also facilitate integration with various devices and systems that are designed to accommodate standard battery sizes and shapes.

The interface section 1002 is located at the bottom of the battery assembly 1000. The interface section 1002 includes a series of circular elements arranged in a row along the base. These circular elements may serve as electrical contacts or connection points for the battery assembly 1000. The circular design of these elements may ensure consistent and reliable electrical connections regardless of the battery's rotational orientation. The interface section may incorporate protective features such as recessed contacts or insulating barriers to prevent accidental short circuits or environmental contamination.

In some cases, the interface section 1002 may be designed to provide a standardized connection interface for the battery assembly 1000. This standardization may allow for compatibility with various devices or charging systems, potentially enhancing the versatility of the battery assembly 1000. The standardized interface may follow industry-recognized specifications, ensuring broad compatibility across different manufacturers and device types. It may also include smart connection capabilities, allowing for bidirectional communication between the battery and connected devices for optimized power management and diagnostics.

In various embodiments, efforts may be made to develop a standardized, universal interface for the energy pods. This standardization may ensure compatibility across different manufacturers or devices, potentially increasing the widespread adoption and utility of the biodegradable battery system.

Above the interface section 1002 is the power cell 1004, which occupies the middle portion of the battery assembly 1000. The power cell 1004 is labeled as containing biodegradable material, indicating its environmentally friendly composition. This biodegradable composition may include organic electrolytes, bio-based separators, and electrodes derived from sustainable sources. The power cell may be designed with multiple internal layers or compartments to maximize energy density while maintaining the overall cylindrical shape.

To be clear, the arrangement shown in FIG. 10 shows an embodiment where the power cell 1004 includes the biodegradable material which can be easily removed and/or swapped out, while the pod-base interface 1002 and the energy pod 1006 may be repeatedly and consistently used.

In some cases, the power cell 1004 may be designed to maximize energy storage capacity while maintaining a compact form factor. The use of biodegradable materials in the power cell 1004 may address environmental concerns associated with traditional battery technologies. The biodegradable components may be engineered to break down safely after the battery's useful life, potentially reducing electronic waste and environmental impact. Advanced manufacturing techniques may be employed to create highly efficient electrode structures and optimize the internal architecture of the power cell for maximum energy density.

The top section of the battery assembly 1000 consists of the energy pod 1006. The energy pod 1006 forms a cap-like structure that completes the cylindrical assembly. The energy pod 1006 may contain additional energy storage components or control systems for the battery assembly 1000. This cap-like design may serve multiple functions, including sealing the internal components, providing structural support, and housing sophisticated electronics for battery management and monitoring.

In various embodiments, the energy pods may contain magnesium in strip or powder form along with bio-organic acids, separated by a designed activation mechanism. When activated and interfaced with the circuitry in the base, these components may initiate electricity generation to power connected devices. This design may allow for on-demand power generation and efficient energy storage.

In some cases, the energy pod 1006 may be designed to be removable or replaceable, potentially allowing for easy maintenance or upgrades to the battery assembly 1000. This modular approach may contribute to the longevity and adaptability of the battery system. The removable nature of the energy pod may allow for the integration of new technologies or replacement of worn components without discarding the entire battery assembly. It may also facilitate customization of battery performance characteristics for specific applications by swapping different types of energy pods.

The overall configuration of the battery assembly 1000 shows how these components—the interface section 1002, power cell 1004, and energy pod 1006—may be combined to form a complete battery unit. This arrangement may allow for efficient use of space and simplified assembly or disassembly processes. The stacking may also enable a logical flow of energy from the power cell through the control systems in the energy pod to the interface section for output. This configuration may facilitate automated assembly processes and quality control checks at each stage of construction.

In some cases, the vertical stacking of components in the battery assembly 1000 may facilitate heat dissipation and thermal management. The cylindrical form factor may allow for uniform heat distribution, potentially enhancing the performance and lifespan of the battery assembly 1000. The vertical arrangement may create natural convection channels for heat flow, while the cylindrical shape provides a large surface area for heat dissipation. Other thermal management materials or structures may be integrated between components to further optimize heat distribution and prevent localized hot spots that could degrade battery performance.

The battery assembly 1000 exemplifies a resolution to challenges in creating modular and environmentally friendly energy storage solutions. By incorporating biodegradable materials in the power cell 1004 and utilizing a modular design with distinct sections, the battery assembly 1000 addresses concerns related to electronic waste and the need for adaptable power sources.

In various embodiments, the battery assembly 1000 may incorporate additional features to enhance its functionality or performance. For example, the interface section 1002 may include smart connection capabilities that allow the battery assembly 1000 to communicate with connected devices, potentially enabling adaptive power management based on device requirements. In various embodiments, the power cell 1004 may be designed with multiple sub-compartments containing different types of biodegradable materials. This configuration may allow for the optimization of energy storage characteristics while maintaining the overall environmentally friendly nature of the battery assembly 1000.

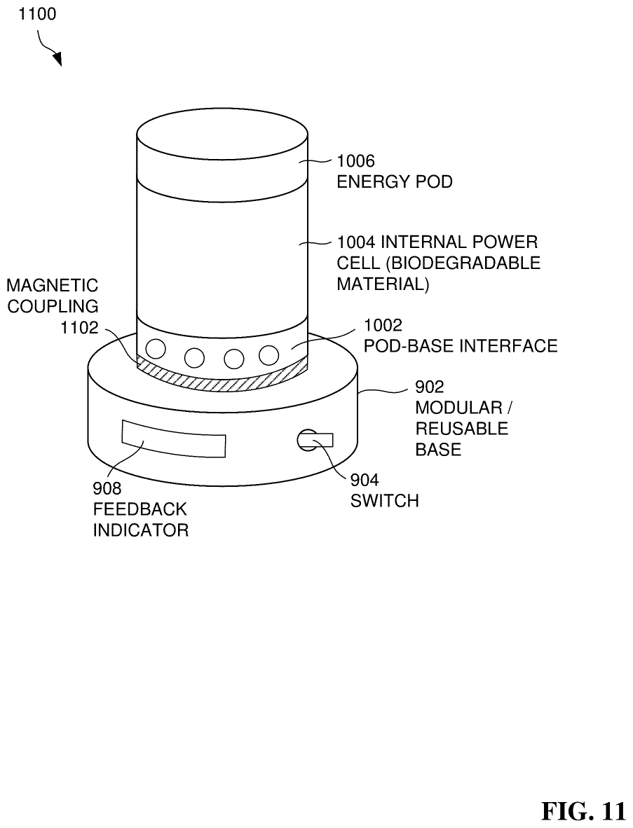

FIG. 11 illustrates a side view of a battery assembly 1100, in accordance with one embodiment. As an option, the side view of the battery assembly 1100 may be implemented in the context of any one or more of the embodiments set forth in any previous and/or subsequent Figures and/or description thereof. Of course, however, the side view of the battery assembly 1100 may be implemented in the context of any desired environment. Further, the aforementioned definitions may equally apply to the description below.

The battery assembly 1100 includes an energy pod 1006 positioned above a modular base 902. The energy pod 1006 contains an internal power cell 1004 that may be composed of biodegradable material. The modular base 902 may serve as a foundation for the battery assembly 1100, providing structural support and housing for various components. The energy pod 1006 may be designed with a specific shape and size to optimize its fit with the modular base 902, ensuring a secure and efficient connection. The internal power cell 1004 may incorporate multiple layers of biodegradable materials, each serving a specific function such as energy storage, ion transport, or structural support. The modular base 902 may include advanced circuitry for power management and communication with the energy pod 1006, potentially allowing for real-time monitoring and optimization of battery performance.

In some cases, the power cell 1004 may be designed to maximize energy storage capacity while maintaining a compact form factor. The use of biodegradable materials in the power cell 1004 may address environmental concerns associated with traditional battery technologies. The biodegradable materials may be engineered to break down into non-toxic components under specific environmental conditions, potentially reducing the ecological impact of battery disposal. The compact form factor may be achieved through advanced manufacturing techniques such as 3D printing or nano-scale material engineering, allowing for precise control over the internal structure of the power cell 1004. The energy storage capacity may be further enhanced through the use of novel electrode materials or electrolyte compositions derived from sustainable sources.

A magnetic coupling 1102 may be provided between the energy pod 1006 and the modular base 902. The magnetic coupling 1102 may allow for secure attachment of the energy pod 1006 to the modular base 902 while facilitating easy removal and replacement when needed. The magnetic coupling 1102 may utilize an array of strategically placed magnets to create a strong and uniform connection across the interface. This magnetic arrangement may also serve to align the energy pod 1006 correctly with the modular base 902, ensuring proper electrical contact and mechanical stability. The magnetic field may be designed to repel foreign metallic objects, potentially reducing the risk of short circuits or contamination.

In various embodiments, the magnetic coupling between the energy pods and the modular base may utilize small magnets and iron or steel components. This coupling mechanism may provide secure attachment while allowing for easy removal and replacement of energy pods, enhancing the system's modularity and user-friendliness.

In some cases, the magnetic coupling 1102 may be designed with specific strength characteristics to ensure a stable connection between the energy pod 1006 and the modular base 902 during normal use, while still allowing for intentional separation when replacement or maintenance may be required. The magnetic strength may be calibrated to withstand expected vibrations and impacts during typical usage scenarios, such as in portable devices or electric vehicles. The coupling may incorporate a gradual release mechanism, where the magnetic force decreases progressively as the energy pod 1006 is pulled away from the modular base 902, providing a smooth and controlled separation process. Additionally, the magnetic coupling 1102 may include safety features that automatically disconnect the power flow if an unexpected separation is detected.

The interface section 1002 may be positioned between the energy pod 1006 and the modular base 902, facilitating connection between these components. The interface section 1002 may include electrical contacts or connection points that enable power transfer and communication between the energy pod 1006 and the modular base 902. These electrical contacts may be designed with self-cleaning mechanisms to maintain reliable connections over time. The interface section 1002 may also incorporate error-checking protocols to ensure proper alignment and connection before allowing power transfer. Additionally, the interface may include thermal management features to dissipate heat generated during high-current operations.

In some cases, the interface section 1002 may be designed with standardized connectors to ensure compatibility between different models of energy pods and modular bases. This standardization may enhance the interchangeability and upgradability of components within the battery assembly 1100. The standardized connectors may follow industry-wide protocols, potentially allowing for cross-compatibility with other manufacturers' components. The interface may also include smart identification systems that can recognize different types of energy pods and adjust power management strategies accordingly. Furthermore, the standardized design may facilitate automated assembly and testing processes, potentially reducing manufacturing costs and improving quality control.

The modular base 902 may include an activation switch 904 positioned on the exterior surface. The activation switch 904 may serve as a user interface element for controlling the operation of the battery assembly 1100. The switch may be designed with multiple activation modes, allowing users to select different power output levels or operational modes. The activation switch 904 may be integrated with a microcontroller that manages the power distribution and monitors system health. Additionally, the switch may incorporate biometric security features, such as fingerprint recognition, to prevent unauthorized activation of the battery assembly.

A feedback indicator 908 may also be incorporated consistent with the discussion herein with respect to FIG. 9. In some cases, the feedback indicator 908 may utilize LED lights or a small display screen to communicate information such as battery charge level, operational status, or error conditions. The feedback system may also include auditory or haptic elements to provide status updates through multiple sensory channels, enhancing user awareness and accessibility.

By incorporating the magnetic coupling 1102 between the energy pod 1006 and the modular base 902, the configuration addresses the need for easily replaceable and upgradable battery components. Additionally, the inclusion of the activation switch 904 and feedback indicator 908 on the modular base 902 exemplifies a resolution to problems of user control and monitoring in battery systems. This design may allow for intuitive operation and real-time status updates, particularly for biodegradable systems, potentially enhancing user experience and facilitating proper maintenance of the battery assembly 1100.

In various embodiments, the magnetic coupling 1102 may be designed with alignment features to ensure proper orientation when connecting the energy pod 1006 to the modular base 902. These features may include keyed surfaces or magnetic polarity arrangements that guide users to correctly position the components during assembly or replacement.

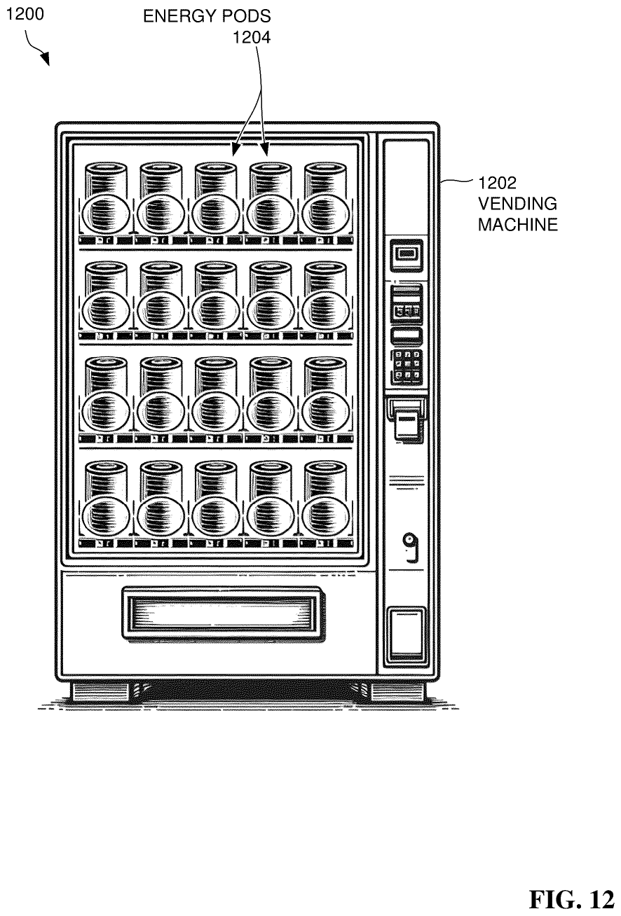

FIG. 12 illustrates a front view of a battery system 1200, in accordance with one embodiment. As an option, the battery system 1200 may be implemented in the context of any one or more of the embodiments set forth in any previous and/or subsequent Figures and/or description thereof. Of course, however, the battery system 1200 may be implemented in the context of any desired environment. Further, the aforementioned definitions may equally apply to the description below.

The battery system 1200 includes a vending machine 1202 designed for dispensing energy pods 1204. The vending machine 1202 comprises a rectangular housing with a transparent front panel that displays multiple rows of the energy pods 1204.

The vending machine 1202 includes a control panel section positioned on the right side of the housing, which contains various interface elements such as a keypad and payment processing components. A dispensing slot may be located at the bottom of the vending machine 1202. The control panel may feature tactile buttons for durability and ease of use, as well as a high-contrast display for clear visibility in various lighting conditions. The payment processing components may support multiple payment methods, including contactless options, to enhance user convenience. In some cases, the control panel may incorporate touchscreen technology for user interaction, potentially allowing for more intuitive selection of energy pods 1204 and providing additional information about pod specifications or compatibility.

The energy pods 1204 appear as cylindrical containers stored within individual compartments of the vending machine 1202, allowing for organized storage and controlled dispensing of the pods. Each energy pod may be equipped with RFID tags or QR codes to enable automated inventory tracking and provide instant information about the pod's specifications and compatibility when scanned.

In some cases, the individual compartments housing the energy pods 1204 may be temperature-controlled to maintain optimal storage conditions for the biodegradable components within the pods. This temperature control may help extend the shelf life of the energy pods 1204 and ensure consistent performance upon dispensing.

In some cases, the vending machine 1202 may be equipped with inventory management systems that track the quantity and types of energy pods 1204 available. This system may enable automatic reordering of pods when stock levels are low and provide usage data for optimizing the selection of energy pod types offered in specific locations. The inventory management system may utilize machine learning algorithms to predict demand patterns based on factors such as location, time of day, and local events, allowing for proactive restocking and minimizing out-of-stock situations. It may also integrate with a cloud-based platform for real-time monitoring and remote management of multiple vending machines across different locations.

In various embodiments, the vending machine 1202 may incorporate wireless communication capabilities. These capabilities may allow for remote monitoring of inventory levels, real-time reporting of sales data, and over-the-air updates to pricing or product information displayed on the control panel. Additionally, the vending machine 1202 may include a recycling compartment for used energy pods 1204. This feature may encourage users to return depleted pods for proper recycling or refurbishment, potentially reducing waste and supporting the overall sustainability goals of the biodegradable battery system. Further, the vending machine 1202 may be designed with modular components that allow for easy reconfiguration of the internal layout. This modularity may enable the machine to accommodate different sizes or shapes of energy pods 1204 as the technology evolves, ensuring the long-term adaptability of the distribution system.

Taking a step back, FIG. 12 illustrates a key aspect of the modular biodegradable battery system: its accessibility and case of distribution. The vending machine 1202 showcases how the energy pods 1204 can be made readily available to consumers in a familiar and convenient format. This configuration demonstrates that the modular energy pods are not just a specialized technology, but a practical, everyday power solution that can be easily obtained and replaced as needed. The transparent front panel of the vending machine 1202, displaying multiple rows of energy pods 1204 arranged in an organized grid pattern, allows users to visually select the appropriate pod for their needs (i.e. each pod grouping may include a different power density/capacity, etc.). The inclusion of a control panel and payment processing components further emphasizes the user-friendly nature of this distribution system. By presenting the energy pods in a vending machine format, the figure underscores the system's potential for widespread adoption and integration into daily life. This approach to distribution aligns with the overall goal of making sustainable, biodegradable energy solutions as accessible and convenient as possible, potentially encouraging broader adoption of environmentally friendly power options in various settings, from residential areas to public spaces and workplaces.

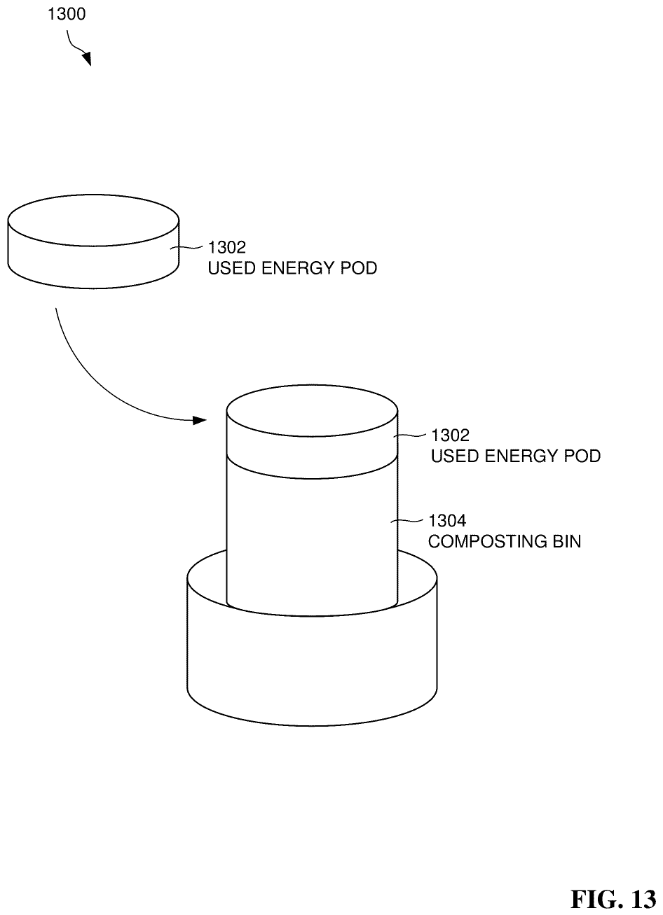

FIG. 13 illustrates a battery system 1300 demonstrating a composting process for a used energy pod, in accordance with one embodiment. As an option, the battery system 1300 may be implemented in the context of any one or more of the embodiments set forth in any previous and/or subsequent Figures and/or description thereof. Of course, however, the battery system 1300 may be implemented in the context of any desired environment. Further, the aforementioned definitions may equally apply to the description below.

The battery system 1300 includes a used energy pod 1302 being disposed of in a composting container 1304. The used energy pod 1302 may be depicted both separately and positioned within the composting container 1304, demonstrating the disposal process. The used energy pod 1302 may have various shapes and sizes depending on its original application, such as cylindrical for portable devices or prismatic for larger energy storage systems. The composting container 1304 may be designed with multiple compartments to accommodate different stages of the decomposition process, potentially allowing for a continuous flow of materials from initial disposal to final compost production.

In some cases, the used energy pod 1302 may be designed with biodegradable materials that facilitate its decomposition in the composting container 1304. The biodegradable components of the used energy pod 1302 may include organic materials used in the electrolyte or biodegradable plastics used in the casing. These materials may be specifically engineered to break down under composting conditions, with controlled degradation rates to ensure complete decomposition within a predetermined timeframe. The biodegradable plastics may incorporate additives that enhance their susceptibility to microbial breakdown, potentially accelerating the overall composting process.

The composting container 1304 may provide a receptacle for collecting and processing the biodegradable components of the used energy pod 1302. The composting container 1304 may be designed to maintain optimal conditions for the decomposition process, such as proper moisture levels and aeration. The container may incorporate sensors to monitor key parameters like temperature, humidity, and PH levels, automatically adjusting conditions to optimize the decomposition rate. It may also feature a modular design, allowing for easy expansion or reconfiguration to accommodate varying volumes of used energy pods.

In some cases, the composting container 1304 may include features that accelerate the decomposition of the used energy pod 1302. These features may include mechanisms for turning or mixing the contents, temperature control systems, or the addition of composting agents that enhance microbial activity. The turning mechanisms may be automated, using programmable schedules to ensure consistent mixing without manual intervention. Temperature control systems may utilize heat generated by the composting process itself, supplemented by external heating elements when necessary to maintain optimal decomposition temperatures. Composting agents may be specially formulated to target the specific materials used in the energy pods, potentially including engineered microorganisms designed to break down particular components more efficiently.

The battery system 1300 demonstrates how the used energy pod 1302 may be placed into the composting container 1304 for environmentally conscious disposal after its power has been depleted. This process may allow for the recycling of organic materials and the reduction of electronic waste associated with traditional battery disposal methods. The system may incorporate a user-friendly interface that guides individuals through the proper disposal process, potentially including educational information about the environmental benefits of composting used energy pods. Additionally, the composting process may be integrated with local waste management systems, allowing for efficient collection and processing of composted materials on a larger scale.

In some cases, the composting process may be designed to separate biodegradable components from non-biodegradable elements of the used energy pod 1302. This separation may allow for the recovery of materials such as metals or conductive elements that can be recycled through other means. The separation process may utilize advanced sorting technologies such as magnetic separation for ferrous metals, eddy current separation for non-ferrous metals, and optical sorting for other recyclable materials. The recovered materials may be further processed on-site or sent to specialized recycling facilities, potentially creating a closed-loop system where recovered materials are used in the production of new energy pods or other electronic components.

The battery system 1300 exemplifies a resolution to challenges in creating environmentally friendly disposal methods for energy storage devices. By incorporating biodegradable materials into the energy pod design and providing a composting process, the system addresses concerns related to electronic waste and the environmental impact of battery disposal. The use of the composting container 1304 as part of the battery system 1300 demonstrates a solution to the problem of end-of-life management for energy storage devices. This approach may allow for the reintegration of organic materials into the environment, potentially reducing the accumulation of waste in landfills and minimizing the release of harmful substances.

In various embodiments, the composting container 1304 may be equipped with sensors that monitor the decomposition process of the used energy pod 1302. These sensors may track factors such as temperature, moisture content, and gas emissions, potentially allowing for optimization of the composting conditions and providing data on the environmental impact of the disposal process. In various embodiments, the battery system 1300 may be adapted for use in various applications, including electric vehicles, consumer electronics, and power wall generators. The composting process may be scaled to accommodate the different sizes and quantities of used energy pods generated by these diverse applications, ensuring a consistent and environmentally friendly disposal method across multiple sectors.

In various embodiments, the organic material used in the energy pods may comprise at least one of lemon zest, banana, berries, orange zest, apples, grapes, or pineapple. These organic materials are selected for their biodegradability and potential to generate electrical energy when combined with an acidic solution. In some aspects, the biodegradable slurry mixture may comprise a 1:1 ratio of organic material and vinegar. This ratio may be optimized to balance energy output and decomposition rate, ensuring efficient power generation while maintaining the biodegradable nature of the battery system.

The activation mechanism of each energy pod may comprise a breakable seal between the compartment containing organic material and the separate compartment containing vinegar. This seal may be designed to rupture upon user activation or when a specific condition is met, such as reaching a certain temperature or pressure. Additionally, the activation mechanism may include a mechanical agitator configured to mix the organic material and vinegar upon activation. This agitator may be a simple stirring device or a more complex mechanism that ensures thorough mixing of the components to create an optimal biodegradable slurry mixture for energy generation.

In some embodiments, each energy pod may comprise an RFID tag or QR code. These identification technologies allow for efficient tracking and management of individual energy pods throughout their lifecycle. The vending machine may be equipped with a scanner configured to read the RFID tag or QR code. This scanner enables automated inventory tracking, providing real-time information about the quantity and types of energy pods available in the vending machine. Furthermore, the scanner may access and display information about pod specifications and compatibility, assisting users in selecting the appropriate energy pod for their specific device or application.

To enhance the performance and longevity of the energy pods, the first electrode and the second electrode may be treated with surface modifications. These modifications may include chemical treatments, physical texturing, or the application of specialized coatings. Additionally, the electrodes may incorporate porous structures or nanoparticle coatings to increase their effective surface area. These enhancements can significantly improve the electrical performance of the electrodes, potentially increasing the power output and efficiency of the energy pods while maintaining their biodegradable properties.

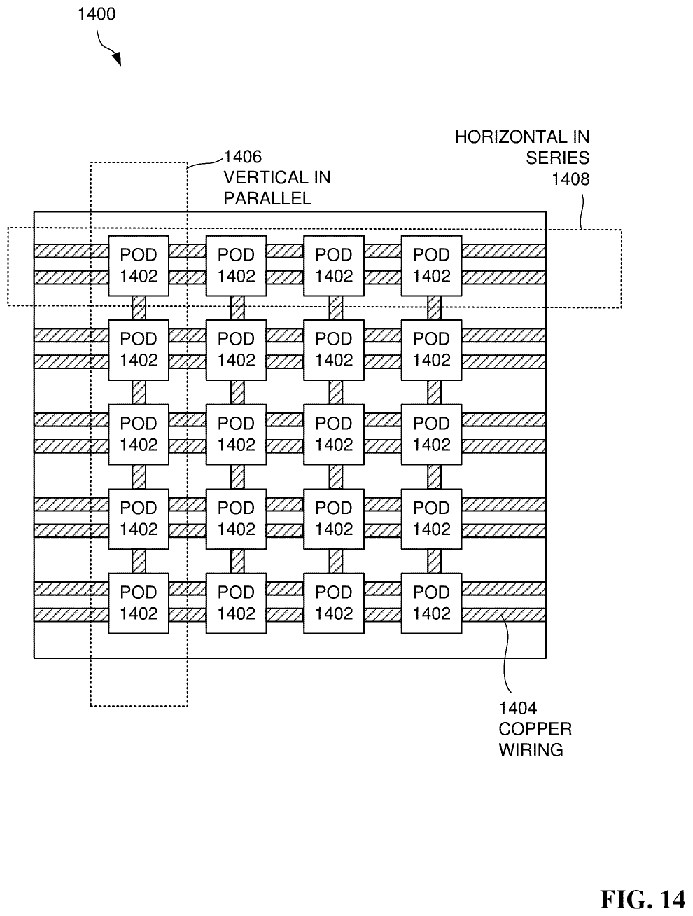

FIG. 14 depicts a battery configuration 1400 showing an arrangement of multiple energy pods in a grid pattern, in accordance with one embodiment. As an option, the battery configuration 1400 may be implemented in the context of any one or more of the embodiments set forth in any previous and/or subsequent figure(s) and/or description thereof. Of course, however, the battery configuration 1400 may be implemented in the context of any desired environment. Further, the aforementioned definitions may equally apply to the description below.

As shown, the battery configuration 1400 shows an arrangement of multiple energy pods 1402 in a grid pattern. In this embodiment, the battery configuration 1400 includes energy pods 1402 arranged in a 5×4 matrix formation, though it should be understood that any number of pods can be included in various configurations to meet specific power requirements.

The energy pods 1402 are interconnected through copper wiring 1404 that provides electrical connections between the pods. The copper wiring 1404 creates a network that enables power distribution throughout the configuration. Each energy pod 1402 is designed to come into contact with both a copper electrode and a magnesium electrode (located within each of the energy pods 1402), facilitating the electrochemical reactions necessary for power generation.

The battery configuration 1400 incorporates both vertical connections 1406 and horizontal connections 1408. The vertical connections 1406 are arranged in parallel, connecting energy pods 1402 along the vertical axis. This parallel configuration allows for the amplification of current output. The horizontal connections 1408 are arranged in series, linking energy pods 1402 along the horizontal axis. The series configuration enables an increase in voltage output.

This versatile arrangement allows for customizable power outputs. For example, each vertical column of energy pods can be connected in parallel to increase the amperage, and then each of these parallel groupings can be connected in series horizontally to increase the overall voltage of the system. This flexibility in configuration enables the battery system to be tailored to various power requirements for different applications.

The modular nature of this design allows for scalability, where additional energy pods 1402 can be added to the configuration to increase power output as needed. This scalability makes the battery configuration 1400 adaptable to a wide range of power needs, from small portable devices to larger energy storage systems.

In some embodiments, the energy pods 1402 may be designed to be easily replaceable, allowing for quick swapping of depleted pods with fresh ones. This feature could enable continuous power supply in applications where downtime for recharging is not feasible.

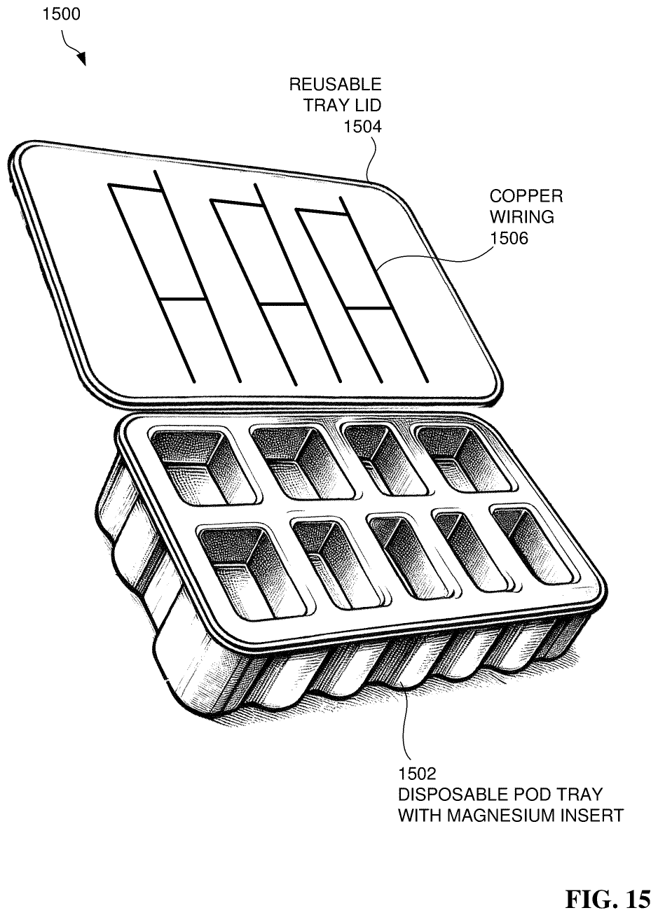

FIG. 15 illustrates an exploded view of a battery assembly 1500 comprising a disposable pod tray and a reusable tray lid, in accordance with one embodiment. As an option, the battery assembly 1500 may be implemented in the context of any one or more of the embodiments set forth in any previous and/or subsequent figure(s) and/or description thereof. Of course, however, the battery assembly 1500 may be implemented in the context of any desired environment. Further, the aforementioned definitions may equally apply to the description below.

The battery assembly 1500 comprises a disposable pod tray 1502 and a reusable tray lid 1504. The disposable pod tray 1502 includes multiple compartments arranged in a grid pattern. Each of the compartments may include a magnesium insert. Additionally, each compartment in the disposable pod tray 1502 represents an individual energy unit, designed to interface with electrodes when the assembly is complete.

The reusable tray lid 1504 features corresponding openings that align with the compartments of the disposable pod tray 1502. Copper wiring 1506 is integrated into the reusable tray lid 1504, arranged in a pattern that corresponds to the compartment layout of the disposable pod tray 1502. This copper wiring 1506 forms the circuitry necessary for power distribution.

In this configuration, each row of energy units in the disposable pod tray 1502 is designed to function in series, potentially allowing for voltage amplification across the row. The modular nature of this design may enable customization of power output by adjusting the number of rows or units utilized. In like manner to FIG. 14, the circuitry may be configured to increase both the amps and volts of the system (involving both parallel and series configuration).

Further, the circuitry arrangement in the reusable tray lid 1504 may facilitate electrical connections between individual pods in the disposable pod tray 1502. The copper wiring 1506 integrated into the reusable tray lid 1504 may be configured to create either parallel or series connections between the pods. For instance, the wiring may connect pods within the same row in series to increase voltage output, while connections between rows may be in parallel to amplify current. This flexible arrangement may allow for customizable power outputs to suit various applications. When the assembly is inverted and the slurry in each pod contacts the copper wiring, it may complete the circuit, enabling electricity to flow through the predetermined pathways created by the wiring configuration.

In one embodiment, the copper wiring may be separate from the individual energy pods. Unlike previous configurations (such as those shown in FIGS. 2A and 2B), where copper wires were contained within the pouches, FIG. 15 shows a configuration keeps the wiring separate in the reusable tray lid 1504. This separation may offer several advantages, including easier recycling of components and potentially extended life of the copper circuitry.

In one embodiment, the system may be designed to be activated by flipping the entire assembly. When inverted, gravity may cause the slurry within each compartment of the disposable pod tray 1502 to come into contact with the copper wiring 1506 on the reusable tray lid 1504. This action completes the circuit (along with the magnesium found in each of the compartments), initiating the power generation process. It is acknowledged that while gravity can be utilized to complete the electrical connection by inverting the battery assembly, future iterations of the system may incorporate alternative user-friendly mechanisms to activate the circuit without the need for flipping the unit.

For example, the system may employ a sliding mechanism where the user can simply slide a component to bring the electrolyte into contact with the electrodes. This could involve a movable barrier between the slurry compartment and the electrode interface that can be easily displaced by the user. Another potential approach may involve a twisting or rotating action, where the user turns a portion of the assembly to align the electrolyte-containing compartments with the electrode contacts. This rotational design could provide a smooth and intuitive activation process.

In some embodiments, the system may incorporate a push-button or lever mechanism that, when activated, causes the electrolyte to flow or move into position to complete the circuit. This could be achieved through the use of flexible membranes or channels within the battery assembly.

Additionally, the design of the battery assembly 1500 may offer significant advantages in terms of sustainability and reusability. The disposable pod tray 1502, which may contain the biodegradable components including the magnesium inserts and organic slurry, may be easily removed (even as an entire tray assembly) and discarded in an environmentally friendly manner after use. Its biodegradable nature may allow for safe decomposition, potentially reducing electronic waste. In contrast, the reusable tray lid 1504, which houses the more durable copper wiring and circuitry, may be retained and used with multiple subsequent disposable pod trays. This separation of biodegradable and reusable components may optimize the system's overall lifecycle, potentially reducing costs and environmental impact while maintaining the integrity of the more complex electrical elements.

Taking a step back, FIGS. 14 and 15 illustrate innovative approaches to miniaturizing and enhancing the portability of the biodegradable battery system. These designs exemplify the focus on creating compact, easily transportable energy solutions that maintain the core principles of modularity and environmental sustainability.

In particular, the compact design of FIG. 14 allows for a high density of energy units within a confined space, potentially maximizing power output while minimizing overall size. The configuration demonstrates how vertical parallel connections and horizontal series connections can be utilized to customize power output, enabling the system to meet various energy requirements within a small form factor. This miniaturized grid design may be particularly beneficial for applications where space is at a premium, such as in portable electronic devices or compact energy storage systems.

The exploded view of the battery assembly 1500 of FIG. 15 features a disposable pod tray 1502 and a reusable tray lid 1504. This design further emphasizes the system's portability and case of use. The separation of the biodegradable energy pods in the disposable tray from the reusable circuitry in the lid allows for a more compact and lightweight overall package. The gravity-activated mechanism, where flipping the assembly completes the circuit, eliminates the need for complex activation systems, potentially reducing bulk and enhancing reliability. This streamlined design, combined with the ability to easily replace the disposable component while retaining the reusable elements, makes the system highly portable and convenient for users who require on-the-go power solutions.

### Use Case Scenario-Fleet Vehicles

A university campus implements the biodegradable battery system with modular energy pods to power its fleet of electric maintenance vehicles. The facilities management department installs a vending machine dispensing energy pods in a central location accessible to maintenance staff. When a vehicle's battery runs low, the operator visits the vending machine, selects an appropriate energy pod, and easily replaces the depleted pod in their vehicle with the fresh one. The used pod is then deposited in a nearby composting container. As the pods decompose, they contribute to the campus's organic waste recycling program, producing compost for use in landscaping. This system reduces the university's electronic waste, supports its sustainability initiatives, and provides a convenient, always-available power source for its electric vehicle fleet. The modular nature of the energy pods allows the university to easily scale its power needs during peak maintenance periods, while the biodegradable components align with the institution's commitment to environmental stewardship.

### Use Case Scenario-Festival

A large music festival implements the biodegradable battery system to power its temporary lighting and sound equipment. The festival organizers set up multiple vending machines throughout the venue, each stocked with energy pods of various capacities. As different stages and areas require power, technicians can quickly obtain the appropriate energy pods from the nearest vending machine. The modular nature of the system allows for easy scaling-smaller pods for individual speakers or lights, and larger pods for main stage equipment. When a pod is depleted, it's swapped out for a fresh one, with the used pod placed in designated composting bins. These bins are periodically collected and taken to an on-site composting facility, where the biodegradable components break down rapidly due to optimized conditions. The resulting compost is then used to restore the festival grounds post-event, helping to mitigate the environmental impact of the large gathering. This system not only provides reliable, scalable power for the duration of the festival but also aligns with the event's eco-friendly messaging, demonstrating a commitment to sustainability that resonates with environmentally conscious attendees.

Further, in various embodiments, the energy pod system may be designed to accommodate a range of sizes and capacities. This scalability may allow for applications ranging from small portable devices to larger power requirements such as electric vehicle battery extensions and eVTOL (electric vertical takeoff and landing) aircraft batteries. The ability to customize and miniaturize the pods may expand their potential use cases across various industries.

### Use Case Scenario-Disaster

A disaster relief organization adopts the biodegradable battery system for its emergency response operations. The organization equips its mobile command centers with compact vending machines that dispense various sizes of energy pods. When responding to a natural disaster, these units can be quickly deployed to affected areas, providing a reliable and scalable power source for critical equipment such as medical devices, communication systems, and water purification units. The modular nature of the energy pods allows relief workers to easily distribute power where it's needed most, adapting to changing requirements as the situation evolves. Used pods are collected in specialized composting containers designed for rapid biodegradation. These containers are engineered to accelerate the breakdown process, turning the depleted pods into nutrient-rich soil within weeks. This soil is then used in local reforestation or agricultural recovery efforts, directly contributing to the area's long-term rehabilitation. The biodegradable aspect of the system ensures that no electronic waste is left behind after the relief efforts conclude, aligning with the organization's mission to provide aid without causing additional environmental harm.

### Use Case Scenario-Residential Use

In a residential neighborhood, a community-based energy sharing program implements the biodegradable battery system to promote sustainable living and reduce reliance on the traditional power grid. Each household is equipped with a modular base unit that can accommodate various sizes of energy pods. Residents can purchase or rent energy pods from local vending machines strategically placed throughout the community. These pods can be used to power household appliances, charge electric vehicles, or store excess energy generated from personal solar panels. The modular nature of the system allows residents to easily adjust their energy capacity based on their daily needs or during special events like block parties or power outages. When a pod is depleted, residents can simply swap it for a fresh one at the vending machine and deposit the used pod in community composting bins. These bins are regularly collected by a local composting facility, which processes the biodegradable components into nutrient-rich soil for community gardens and parks. The system also incorporates a smartphone app that allows residents to monitor their energy usage, locate the nearest vending machine with available pods, and track their contribution to the community's sustainability efforts. This daily integration of the biodegradable battery system not only provides a flexible and eco-friendly power solution for households but also fosters a sense of community engagement in sustainable practices, demonstrating how innovative energy solutions can seamlessly fit into everyday life while promoting environmental responsibility.

### Improvements Over Existing Battery Systems

Prior art systems have consistently faced significant challenges in developing biodegradable battery technologies that can deliver the power outputs necessary for practical, everyday applications. While previous attempts at creating environmentally friendly energy storage solutions have made strides in biodegradability, they have often fallen short in terms of energy density, power output, and overall performance. This fundamental limitation has hindered the widespread adoption of biodegradable batteries in consumer electronics, electric vehicles, and other power-intensive applications. In contrast, the battery system disclosed herein represents a breakthrough in addressing this long-standing issue.

By ingeniously combining biodegradable materials with innovative design principles, this system achieves a remarkable balance between environmental sustainability and high-performance energy storage. The unique combination of organic electrolytes, optimized electrode materials, and modular energy pod design enables these batteries to deliver power outputs comparable to, and in some cases exceeding, conventional non-biodegradable batteries. This achievement effectively bridges the gap between eco-friendly design and practical functionality, making it possible, for the first time, to implement truly biodegradable battery systems in a wide range of everyday devices and applications without compromising on performance or reliability.

It is to be noted that the battery units and systems disclosed herein improve upon known battery systems in a number of ways: 1) providing for battery cells with biomaterial that are in small form factor (compared to conventional biomaterial based batteries that may require a large amount of biomaterial to create a viable battery cell). This small form factor may be achieved through advanced manufacturing techniques, optimized electrode designs, or novel arrangements of the biodegradable components. 2) yielding higher energy density (compared to conventional biomaterial or even conventional lithium batteries, the battery units disclosed herein are 5-10× more energy dense). This increased energy density may result from the specific combination of biodegradable resources, the design of the electrodes, or the unique properties of the slurry mixture. 3) introducing a new activation triggering mechanism for the biomaterial-based electrolyte. This activation mechanism may involve physical, chemical, or electrical triggers that initiate or enhance the electrochemical reactions within the battery.

These improvements are non-obvious derivations of current systems. The configuration and layout of the basic battery unit, individually and collectively as a system, are wired interconnectedly in a manner distinct and different from the prior art systems. The interconnection may involve novel wiring patterns, innovative use of conductive materials, or unique arrangements of the battery units. In particular, having biomaterial that can be mixed as needed, and arranged in a manner (series or parallel) to output a working energy level (needed by modern devices) in a small form factor (compared to alternative battery systems) is, again, different from and an improvement to existing systems. The on-demand mixing capability may allow for extended shelf life, customization of battery properties, or adaptation to specific energy requirements.

Additionally, the present disclosure addresses significant challenges in energy storage technologies that have long plagued existing battery systems. Prior art solutions have struggled to effectively balance environmental sustainability with performance, often relying on non-biodegradable materials and toxic components that contribute to electronic waste and pose environmental hazards. Conventional battery designs frequently face limitations such as limited energy density, difficulties in recycling or safely disposing of materials, and challenges in creating modular designs that allow for easy replacement or upgrades of individual components. As a result, they often fail to provide a truly sustainable and adaptable power solution, particularly in scenarios requiring customizable energy outputs or environmentally conscious disposal methods.

The disclosed battery system overcomes these deficiencies through a novel approach that utilizes biodegradable materials and a unique electrolyte composition, significantly increasing environmental sustainability while maintaining performance. By incorporating readily available materials such as magnesium and copper for electrodes, combined with an electrolyte composed of organic material and vinegar, the system achieves a level of environmental friendliness previously unattainable in energy storage solutions. Furthermore, the modular design of the energy pods, coupled with the innovative activation mechanism for on-demand mixing of electrolyte components, addresses the challenges of customization and shelf life that have plagued prior art systems. This approach not only reduces environmental impact but also enhances versatility, allowing for easy scaling and adaptation to various applications such as electric vehicles, consumer electronics, and power wall generators. The integration of a composting process for used energy pods further resolves the longstanding issue of battery disposal, effectively transforming what was once electronic waste into a resource for organic waste recycling programs.

### Unexpected Benefits, Unique Challenges, and Improvements Over Existing Technology

In various embodiments, the on-demand mixing of organic material and vinegar in this system may provide significant advantages over pre-mixed electrolytes. The activation unit may trigger a mixing action between the magnesium and the weak acid (fruit acid or vinegar), allowing for instant electricity flow on demand. This design may improve upon previous configurations where electrodes constantly interact with the electrolyte, potentially resulting in a longer shelf life for the energy pods. The separation of components until activation may also prevent degradation of the organic materials over time, potentially enhancing the overall efficiency and reliability of the energy generation process. Furthermore, this on-demand mixing approach may allow for customization of the electrolyte composition based on specific power requirements or environmental conditions.

Additionally, in various embodiments, the biodegradable slurry mixture may possess unique properties that contribute to higher energy density compared to conventional biomaterial-based batteries. The system may utilize weak organic acids (e.g., acetic or citric acid) with high proton availability, which may support improved ionic conductivity for better ion transport and faster electrochemical reaction kinetics. This approach may contribute to higher power output. The interaction between magnesium electrodes and weak acids may potentially achieve energy densities higher than conventional systems. The use of naturally occurring organic acids may also contribute to the overall biodegradability of the system, potentially reducing environmental impact while maintaining high performance. The specific combination of magnesium electrodes and organic acids may create a unique electrochemical environment that optimizes energy production while minimizing waste products.

In various embodiments, the modular design of this system may enable power outputs or energy densities previously unachievable with biodegradable batteries through miniaturization of the modular circuitry design. This approach may allow for more battery units to be contained within the same volume or surface area, potentially amplifying the overall power output of the system. The modular nature may also facilitate easy scaling of power capacity by adding or removing individual units, potentially allowing for customization to meet specific energy requirements. Additionally, this design may enable more efficient heat dissipation and thermal management across the battery system, potentially improving overall performance and longevity.

Further, in various embodiments, synergistic effects between the chosen electrode materials and the biodegradable slurry may contribute to improved performance. Magnesium may naturally react with weak organic acids at a controlled rate, promoting steady ion release without violent or explosive behavior. The weak acidity of the biodegradable slurry may maintain sufficient proton availability to drive ionic conduction while minimizing excessive corrosion or runaway reactions that could otherwise prematurely degrade the electrodes. This balanced interaction may result in a more stable and long-lasting power generation process. The specific chemical properties of the chosen materials may also contribute to the formation of beneficial surface layers on the electrodes, potentially enhancing conductivity and reaction efficiency over time.

In various embodiments, the activation mechanism in this system may differ from or improve upon activation methods in existing battery technologies by separating the modular base unit (with reusable circuitry) from the energy pod unit (100% biocompostable). This design may allow for a seamless user experience, where inserting the pod into the module begins powering devices instantly, potentially offering convenience, portability, and a breakthrough in eco-friendly, grid-independent energy delivery. The separation of reusable and disposable components may significantly reduce waste and improve the overall lifecycle sustainability of the battery system. This approach may also allow for easier upgrades to the base unit technology without requiring replacement of the entire system, potentially extending the useful life of the overall battery configuration.

In various embodiments, the system may be configured for small form factor, high-energy-density biodegradable batteries. The module unit may feature a miniaturized circuitry design deposited with copper. When interfaced with the energy pods, this design may generate electricity for applications ranging from cell phones to homes, electric vehicles, and eVTOLs. These manufacturing techniques may incorporate advanced 3D printing or micro-fabrication processes to achieve precise control over component dimensions and arrangements. The use of biodegradable materials in conjunction with these advanced manufacturing methods may open up new possibilities for creating complex, high-performance structures that can still decompose safely at the end of their lifecycle.

Still yet, in various embodiments, the integration of the vending machine distribution system with the modular battery design may create new possibilities for energy distribution. This approach may establish a decentralized energy network that potentially bypasses limitations of charging infrastructure, grid connectivity, and supply chain complexity, allowing for access to energy anytime and anywhere, even off-grid. The vending machine system may incorporate smart inventory management, potentially optimizing stock levels based on usage patterns and predictive analytics. This distribution method may also enable rapid deployment of energy solutions in emergency situations or remote locations, potentially improving energy access in underserved areas.

In various embodiments, unexpected benefits or applications may have been discovered as a result of the modular and biodegradable nature of this battery system. The miniaturization may allow for more battery units in a confined surface area, potentially increasing energy density while maintaining a lightweight profile. This characteristic may be particularly beneficial for applications such as eVTOLs, where weight is critical for takeoff and flight performance. The biodegradable nature of the energy pods may also open up new possibilities for temporary or disposable electronic devices in fields such as medical diagnostics, environmental monitoring, or disaster relief. The modular design may facilitate easy customization and rapid prototyping of new energy storage configurations, potentially accelerating innovation in various technology sectors.

In various embodiments, the composting process for these energy pods may differ from or improve upon existing methods for disposing of biodegradable electronics. The battery energy pods disclosed herein may be 100% biocompostable, potentially offering an advantage over conventional batteries that contain critical minerals requiring recycling and reuse, and cannot be safely disposed of in the environment. This composting process may be designed to break down the energy pods into beneficial soil amendments, potentially turning waste into a valuable resource for agriculture or landscaping. The decomposition process may also be engineered to neutralize any residual chemical components, ensuring that the composted material is safe for environmental release.

In various embodiments, unique challenges in developing this biodegradable battery system may have been overcome to match or exceed the performance of conventional batteries. These challenges may have included separating the reusable module base unit from the energy pods, optimizing energy density, and developing on-demand activation for extended shelf life. Addressing these challenges may have positioned the system competitively in terms of sustainability and performance.

A number of implementations have been described. Nevertheless, it will be understood that various modifications may be made without departing from the spirit and scope of the disclosure. Accordingly, other implementations are within the scope of the following claims.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A modular biodegradable battery system, comprising:
a plurality of removable energy pods, each energy pod comprising:
a first electrode and a second electrode;
a compartment containing organic material;
a separate compartment containing vinegar;
an activation mechanism configured to initiate mixing of the organic material and the vinegar to create a biodegradable slurry mixture upon activation; and
a reusable modular base configured to removably couple with one or more of the energy pods.

2. The modular biodegradable battery system of claim 1, wherein:
the organic material comprises at least one of lemon zest, banana, berries, orange zest, apples, grapes, or pineapple; and
the biodegradable slurry mixture comprises a 1:1 ratio of organic material and vinegar.

3. The modular biodegradable battery system of claim 1, wherein:
the first electrode comprises magnesium; and
the second electrode comprises copper.

4. The modular biodegradable battery system of claim 1, wherein the activation mechanism comprises:
a breakable seal between the compartment containing organic material and the separate compartment containing vinegar; and
a mechanical agitator configured to mix the organic material and vinegar upon activation.

5. The modular biodegradable battery system of claim 1, wherein the reusable modular base comprises:
a circular form factor;
base circuitry arranged in a grid pattern on an upper surface of the modular base; and
an activation switch positioned on a side of the modular base.

6. The modular biodegradable battery system of claim 5, wherein the reusable modular base further comprises:
a feedback indicator positioned opposite the activation switch; and
the feedback indicator is configured to provide visual information about a status of the battery system.

7. The modular biodegradable battery system of claim 1, wherein:
the reusable modular base comprises a magnetic coupling mechanism; and
each energy pod comprises a corresponding magnetic coupling mechanism configured to removably secure the energy pod to the reusable modular base.

8. The modular biodegradable battery system of claim 7, wherein:
the magnetic coupling mechanism of the reusable modular base comprises an array of magnets arranged to create a strong and uniform connection across an interface with the energy pod; and
the magnetic coupling mechanism is configured to align the energy pod correctly with the reusable modular base.

9. The modular biodegradable battery system of claim 1, wherein each energy pod further comprises:
a biodegradable casing enclosing the first electrode, the second electrode, and the compartments; and
the biodegradable casing is configured to degrade naturally over time after the energy pod is depleted.

10. The modular biodegradable battery system of claim 9, wherein:
the biodegradable casing comprises multiple layers, each layer serving a specific function; and
the functions include at least two of: electrolyte containment, moisture barrier, structural support, or controlled degradation.

11. The modular biodegradable battery system of claim 1, wherein:
the reusable modular base is configured to connect multiple energy pods in series; and
the series connection amplifies a voltage output of the battery system.

12. The modular biodegradable battery system of claim 1, wherein:
the reusable modular base is configured to connect multiple energy pods in parallel; and
the parallel connection amplifies a current output of the battery system.

13. The modular biodegradable battery system of claim 1, further comprising:
a vending machine configured to store and dispense the plurality of removable energy pods; and
the vending machine comprises a transparent front panel displaying multiple rows of energy pods arranged in a grid pattern.

14. The modular biodegradable battery system of claim 13, wherein the vending machine further comprises:
a control panel with a user interface for selecting and purchasing energy pods;
a payment processing component supporting multiple payment methods; and
a dispensing slot with a secure mechanism to prevent unauthorized access to the energy pods.

15. The modular biodegradable battery system of claim 13, wherein:
each energy pod comprises an RFID tag or QR code; and
the vending machine comprises a scanner configured to read the RFID tag or QR code for automated inventory tracking and providing information about pod specifications and compatibility.

16. The modular biodegradable battery system of claim 1, further comprising:
a composting container configured to collect and process depleted energy pods; and
the composting container is designed to maintain optimal conditions for decomposition of the biodegradable components of the energy pods.

17. The modular biodegradable battery system of claim 16, wherein the composting container comprises:
multiple compartments to accommodate different stages of the decomposition process;
sensors to monitor temperature, humidity, and PH levels; and
an automated mixing mechanism to ensure consistent decomposition of the energy pods.

18. The modular biodegradable battery system of claim 1, wherein:
the first electrode and the second electrode are treated with surface modifications to enhance performance and longevity; and
the electrodes incorporate porous structures or nanoparticle coatings to increase effective surface area for improved electrical performance.

19. The modular biodegradable battery system of claim 1, wherein:
the reusable modular base comprises a wireless communication module; and
the wireless communication module is configured to transmit data regarding battery performance, charge status, and usage patterns to a remote monitoring system.

20. The modular biodegradable battery system of claim 19, wherein:
the reusable modular base further comprises a microcontroller; and
the microcontroller is configured to optimize power distribution based on real-time analysis of the transmitted data and connected energy pod configurations.
